(19) United States
(12) Patent Application Publication
(10) Pub. No.: US 2009/0211959 A1
(43) Pub. Date: Aug. 27, 2009

(54) FILTER ARRANGMENT AND METHODS

(75) Inventors: Patrick J. Clint, Minneapolis, MN (US); John R. Hacker, Minneapolis, MN (US); Jodi Billy, Minneapolis, MN (US); Kurt b. Joscher, Burnsville, MN (US)

Correspondence Address: MERCHANT & GOULD PC, P.O. BOX 2903, MINNEAPOLIS, MN, 55402-0903, US

(73) Assignee: Donaldson Company, Inc., Minneapolis, MN (US)

(21) Appl. No.: 12/162,441

(22) PCT Filed: Jan. 29, 2007
(86) PCT No.: PCT/US2007/002658

§ 371 Date: Dec. 30, 2008

Related U.S. Application Data
(60) Provisional application No. 60/763,743, filed on Jan. 30, 2006.
(60) Provisional application No. 60/775,467, filed on Feb. 22, 2006.
(60) Provisional application No. 60/822,974, filed on Aug. 21, 2006.

(51) Int. Cl. B01D 35/26; B01D 29/58; B01D 35/30; B23P 19/00

(52) U.S. Cl. 210/172.4; 210/255; 210/232; 210/235; 210/233; 29/426.1

(57) ABSTRACT

A primary (48, 348, 648, 908) and secondary (50, 350, 650, 910) filter are combined into a single housing (42), and two elements are combined into a single element (46). The primary and secondary filters are fluidly isolated from each other. The primary filter is configured for radial flow, and the secondary filter is configured for axial flow. The filter arrangement can be a top load arrangement or, in another embodiment, a bottom load arrangement. This combination is useable in any system that has a filter upstream of a pump (44) and a filter downstream of a pump (14). The example described is a fuel system. Methods of servicing include simultaneously removing the housing cover along with both the primary and secondary filters.

This application is being filed on 29 Jan. 2007, as a PCT International Patent application in the name of Donaldson Company, Inc., a U.S. national corporation, applicant for the designation of all countries except the U.S., and Patrick Clint, John R. Hacker, Jodi Billy, and Kurt B. Joscher, all citizens of the U.S., applicants for the designation of the US only, and claims priority to U.S. Provisional Patent Application No. 60/763,743, filed Jan. 30, 2006, U.S. Provisional Patent Application No. 60/775,467, filed Feb. 22, 2006, and U.S. Provisional Patent Application No. 60/822,974, filed Aug. 21, 2006.

### TECHNICAL FIELD

This disclosure relates to filter arrangements, systems, and methods. In particular, this disclosure relates to combining at least two filters into a single unit, in which one filter is on the upstream side of a pump, and a second filter is on a downstream side of a pump. In one example embodiment, the disclosure relates to a filter system useable in a fuel system.

### BACKGROUND

FIG. 1 depicts a prior art system. For many diesel engine powered vehicles, there are two fuel filters used in order to provide proper protection for the fuel system components (pumps and injectors). These systems move fuel from the fuel tank 10 through a primary (suction) filter 12 using a transfer pump 14. From pump 14, the fuel passes through a secondary (pressurized) filter 16 and onto the fuel injection system 18. The primary filter 12, on the suction side, usually removes water and some particulate matter. Since water is heavier than fuel, much of the water can separate from the fuel quickly if the flow rate is reduced (settling chamber) prior to reaching the filter media. The media in the primary filter 12 is treated with a substance that makes the media hydrophobic, which acts to strip some of the water out of the fuel before passing through the media. Another method is to add a layer of special media upstream of the standard media in the suction filter 12 which is designed to coalesce the water outside of the fuel. This water migrates down the dirty side of the media and eventually settles into a settling or collector chamber 20.

As a result of emission changes to diesel engines, fuel system pressures have significantly increased. This increased pressure creates a finer spray of fuel in the combustion chamber resulting in a more complete burn, which in turn, helps reduce emissions. Because of the higher pressure, fuel injector components have smaller clearances in their moving parts. These smaller clearances rely heavily on the fuel to maintain these clearances and lubricate during operation (preventing significant wear between the moving parts). Water has a lower film strength than fuel, which greatly decreases lubricating and provides an opportunity for the moving parts to come in contact with each other. At these higher pressures, even a small amount of water can accelerate the rate of wear of the injector components. With currently existing systems, there are two separate filter assemblies that need to be serviced during routine servicing, and they are usually at different locations on the vehicle. Improvements are needed.

### SUMMARY

A filter element is provided including a first media construction with first filter media having a tubular shape defining an open filter interior, the first media construction being configured for radial flow through the first filter media. The filter element also includes a second media construction axially aligned with the first media construction. The second filter construction has second filter media configured for axial flow. The first media construction and the second media construction are fluidly isolated from each other.

A filter arrangement is provided including a filter element, as characterized above, removably positioned within a housing interior. A cover is removably positioned on the housing to provide selective access to the filter element.

A filtration system is provided including a filter arrangement, as characterized above, a fuel tank, a fuel injection system, and a fuel pump arrangement. At least a portion of the fuel pump arrangement is in the housing, with the first filter media circumscribing the fuel pump arrangement.

A method of servicing a filter arrangement includes removing a cover and removing the filter element from the housing. The filter element includes the type as characterized above.

### BRIEF DESCRIPTION OF THE DRAWINGS

FIG. 1 is a schematic depiction of a prior art fuel filter system;

FIG. 2 is a schematic depiction of a system constructed according to principles of this disclosure;

FIG. 3 is an exploded perspective view of one embodiment of a filter arrangement constructed according to principles of this disclosure;

FIG. 4 is a front plan view of the filter arrangement depicted in FIG. 3;

FIG. 5 is a right side elevational view of the filter arrangement depicted in FIG. 3;

FIG. 6 is a perspective view of a housing, including internal components, useable with the filter arrangement depicted in FIG. 3;

FIG. 7 is an alternative perspective view of the housing depicted in FIG. 6;

FIG. 8 is an exploded perspective view of the filter housing of FIGS. 6 and 7, and including internal components;

FIG. 9 is a top plan view of the filter housing, including internal components, of FIG. 8;

FIG. 10 is a cross-sectional view of the filter housing and internal components of FIGS. 6-8, the cross-section being taken along the line 10-10 of FIG. 9;

FIG. 11 is an exploded perspective view of a filter element useable in the filter arrangement of FIG. 3;

FIG. 12 is a bottom plan view of the assembled filter element of FIG. 11;

FIG. 13 is a cross-sectional view of the filter element depicted in FIG. 12, the cross-section being taken along the line 13-13 of FIG. 12;

FIG. 14 is a top plan view of an end cap construction used in the filter element of FIGS. 11-13;

FIG. 15 is a side elevational view of the end cap construction depicted in FIG. 14;

FIG. 16 is a top plan view of a center core construction utilized by the filter element of FIGS. 11-13;

FIG. 17 is a cross-sectional view of the center core construction depicted in FIG. 16, the cross-section being taken along the line 17-17 of FIG. 16;

FIG. 18 is a top plan view of the cover used with the filter arrangement of FIG. 3;

FIG. 19 is a cross-sectional view of the cover depicted in FIG. 18, the cross-section being taken along the line 19-19 of FIG. 18;

FIG. 20 is a perspective view of a portion of the housing depicted in FIG. 3;

FIG. 21 is a top plan view of the filter arrangement of FIG. 3;

FIG. 22 is a cross-sectional view of the filter arrangement of FIG. 21, the cross-section being taken along the line 22-22 of FIG. 21;

FIG. 23 is a cross-sectional view of the filter arrangement of FIG. 21, the cross-section being taken along the line 23-23 of FIG. 21;

FIG. 24 is a side elevational view of an alternative embodiment of an automatic water drain, useable in place of the water bowl with manual drain valve;

FIG. 25 is a top plan view of the automatic water drain depicted in FIG. 24;

FIG. 26 is a cross-sectional view of the automatic drain of FIG. 24, the cross-section being taken along the line 26-26 of FIG. 25;

FIG. 27 is a cross-sectional view of the filter arrangement with an alternative embodiment showing the element connected to the cover, the cross-section being taken along the line 27-27 of FIG. 30;

FIG. 28 is an enlarged view of a portion of the filter arrangement depicted in FIG. 27 and showing the connection between the filter element and the cover;

FIG. 29 is a perspective view of the embodiment of FIGS. 27 and 28, showing a step during servicing, when the element is removed along with removal of the cover;

FIG. 30 is a rear elevational view of the filter arrangement of the embodiment shown in FIGS. 27-29;

FIG. 31 is an exploded perspective view of a second embodiment of a filter arrangement constructed according to principles of this disclosure;

FIG. 32 is a front plan view of the filter arrangement depicted in FIG. 31;

FIG. 33 is a left side elevational view of the filter arrangement depicted in FIG. 31;

FIG. 34 is a perspective view of a housing cover, useable with the filter arrangement depicted in FIG. 31;

FIG. 35 is a perspective view of an end cap construction depicted in FIGS. 42 and 43 and used with the filter element of FIGS. 39-41;

FIG. 36 is an exploded perspective view of the filter housing of FIG. 37, and including internal components;

FIG. 37 is a top plan view of the filter housing, including internal components;

FIG. 38 is a cross-sectional view of the filter housing and internal components of FIGS. 36 and 37, the cross-section being taken along the line 38-38 of FIG. 37;

FIG. 39 is an exploded perspective view of a filter element useable in the filter arrangement of FIG. 31;

FIG. 40 is a bottom plan view of the assembled filter element of FIG. 39;

FIG. 41 is a cross-sectional view of the filter element depicted in FIG. 40, the cross-section being taken along the line 41-41 of FIG. 40;

FIG. 41A is an enlarged, cross-sectional view of portion A-A of the filter element depicted in FIG. 41;

FIG. 42 is a top plan view of an end cap construction used in the filter element of FIGS. 39-41;

FIG. 43 is a cross-sectional view of the end cap construction depicted in FIG. 42, the cross-section being taken along the line 43-43 of FIG. 42;

FIG. 44 is a top plan view of a center core construction utilized by the filter element of FIGS. 39-41;

FIG. 45 is a perspective view of the center core construction depicted in FIG. 44;

FIG. 46 is a side elevational view of the cover used with the filter arrangement of FIG. 31;

FIG. 47 is a cross-sectional view of the cover depicted in FIG. 46, the cross-section being taken along the line 47-47 of FIG. 46;

FIG. 48 is a perspective view of a portion of the housing depicted in FIG. 31;

FIG. 49 is a top plan view of the filter arrangement of FIG. 31;

FIG. 50 is a cross-sectional view of the filter arrangement of FIG. 49, the cross-section being taken along the line 50-50 of FIG. 49;

FIG. 51 is a cross-sectional view of the filter arrangement of FIG. 49, the cross-section being taken along the line 51-51 of FIG. 49;

FIG. 52 is a cross-sectional view of the filter arrangement of FIG. 49, the cross-section being taken along the line 52-52 of FIG. 49;

FIG. 53 is a cross-sectional view of the filter arrangement of FIG. 49, the cross-section being taken along the line 53-53 of FIG. 49;

FIG. 54 is a perspective view of the filter arrangement of FIGS. 32 and 33;

FIG. 55 is an exploded perspective view of another embodiment of a filter arrangement constructed according to principles of this disclosure;

FIG. 56 is a right side elevational view of the filter arrangement depicted in FIG. 55 in an assembled form;

FIG. 57 is a front elevational view of the assembled filter arrangement depicted in FIG. 56;

FIG. 58 is a bottom plan view of the filter arrangement depicted in FIG. 56;

FIG. 59 is a cross-sectional view of the assembled filter arrangement depicted in FIG. 56-58;

FIG. 60 is a top plan view of a filter element usable in the filter arrangement in FIG. 55;

FIG. 61 is a cross-sectional view of the filter element depicted in FIG. 60, the cross-section being taken along the line 61-61 of FIG. 60;

FIG. 62 is a perspective view of an endcap construction used in the filter element of FIGS. 60 and 61;

FIG. 63 is a bottom plan view of the endcap construction depicted in FIG. 62;

FIG. 64 is an enlarged, cross-sectional view of the portion 64-64 of the filter element depicted in FIG. 61;

FIG. 65 is a cross-sectional view of the endcap construction depicted in FIGS. 62 and 63, the cross-section being taken along the line 65-65 of FIG. 63;

FIG. 66 is a perspective view of one media section and center core construction utilized by the filter element depicted in FIGS. 60 and 61;

FIG. 67 is a top plan view of the media section and center core construction of FIG. 66;

FIG. 68 is a perspective view of the center core construction utilized by the filter element of FIGS. 60 and 61;

FIG. 69 is another perspective view of the center core construction of FIG. 68;

FIG. 69A is a side-elevational view of the center core construction depicted in FIGS. 68 and 69;

FIG. 69B is a cross-sectional view of the center core construction, the cross-section being taken along the line B-B of FIG. 69A;

FIG. 70 is a cross-sectional view of the filter housing including internal components, the cross-section being taken along the line 70-70 of FIG. 72;

FIG. 71 is a cross-sectional view of the filter housing and internal components, the cross-section being taken along the line 71-71 of FIG. 72;

FIG. 72 is a front elevational view of the filter housing, including internal components, that is part of the filter arrangement of FIG. 55;

FIG. 73 is an exploded, perspective view of another embodiment of a filter arrangement constructed according to principles of this disclosure;

FIG. 74 is a front elevational view of the assembled filter arrangement depicted in FIG. 73;

FIG. 75 is a right side elevational view of the filter arrangement depicted in FIG. 74;

FIG. 76 is a top plan view of the filter arrangement depicted in FIGS. 74 and 75;

FIG. 77 is a cross-sectional view of the filter arrangement depicted in FIGS. 74-76, the cross-section being taken along the line 77-77 of FIG. 76;

FIG. 78 is a cross-sectional view of the filter arrangement depicted in FIGS. 74-76, the cross-section being taken along the line 78-78 of FIG. 76;

FIG. 79 is a cross-sectional view of the filter arrangement depicted in FIGS. 74-76, the cross-section being taken along the line 79-79 of FIG. 76; and

FIG. 80 is a cross-sectional view of the filter arrangement depicted in FIGS. 74-76, the cross-section being taken along the line 80-80 of FIG. 74.

### DETAILED DESCRIPTION

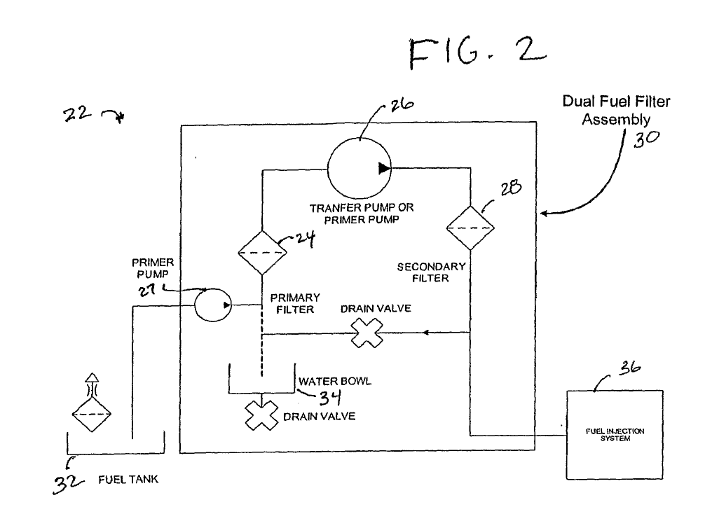

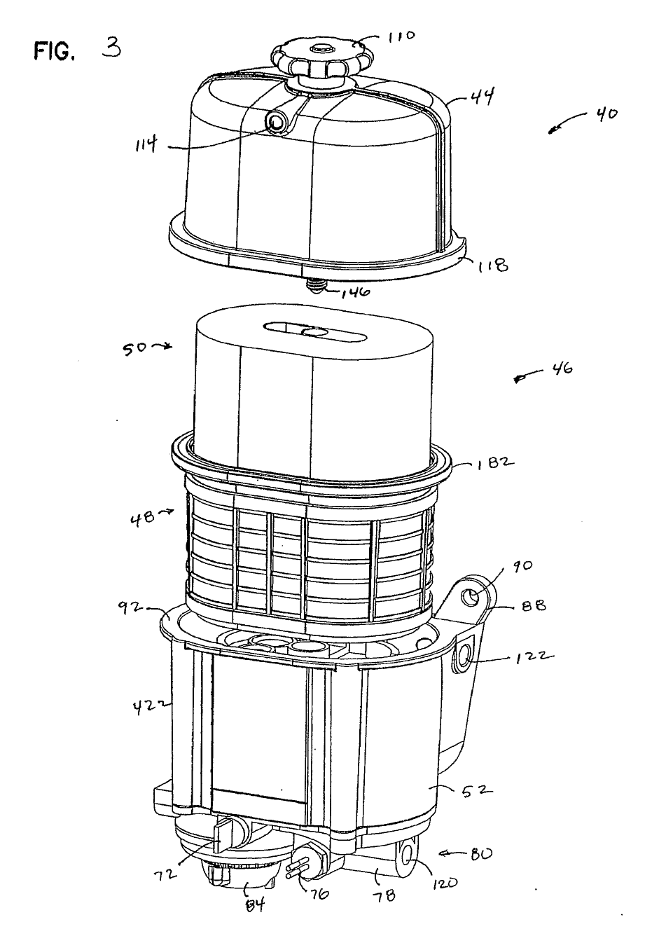

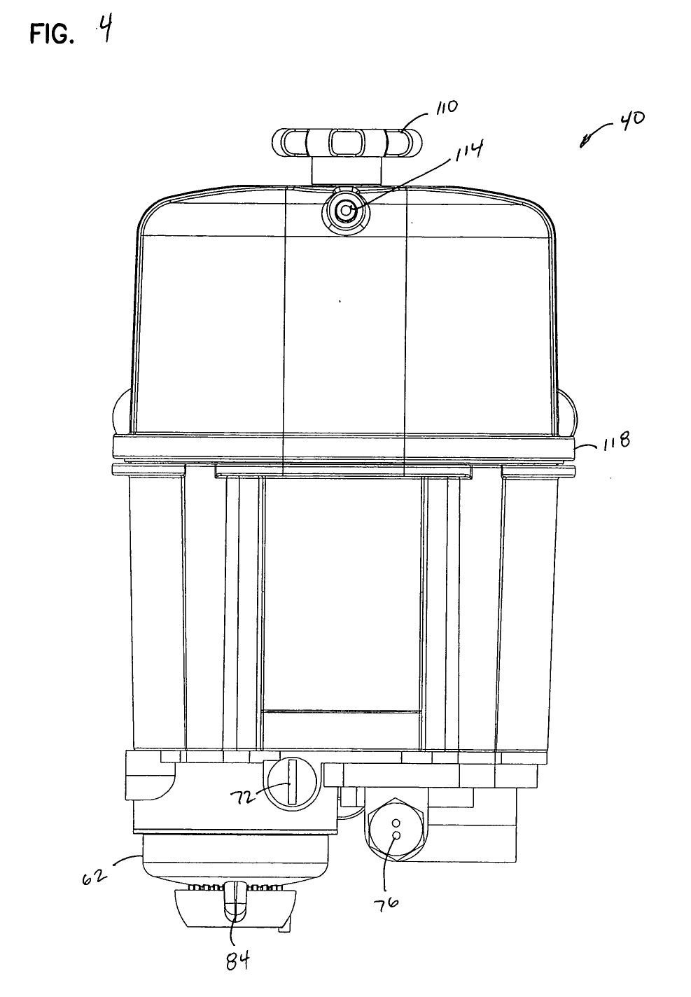

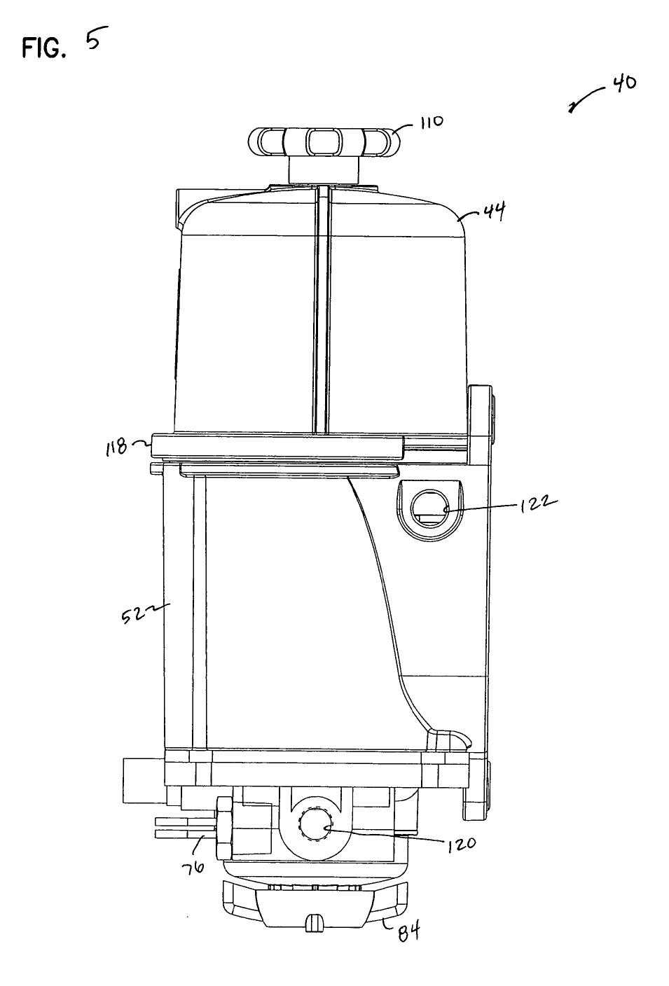

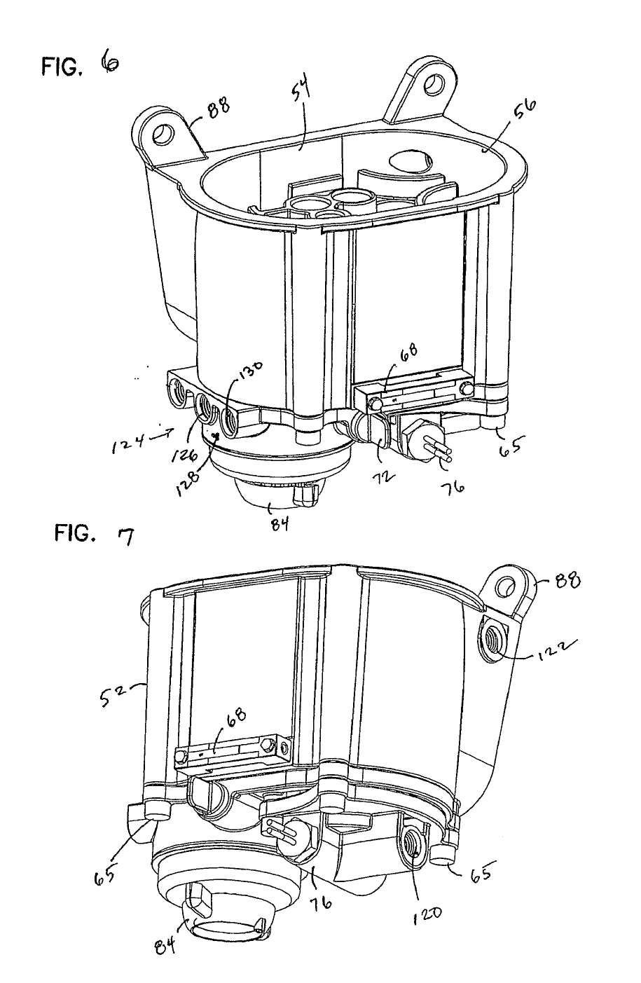

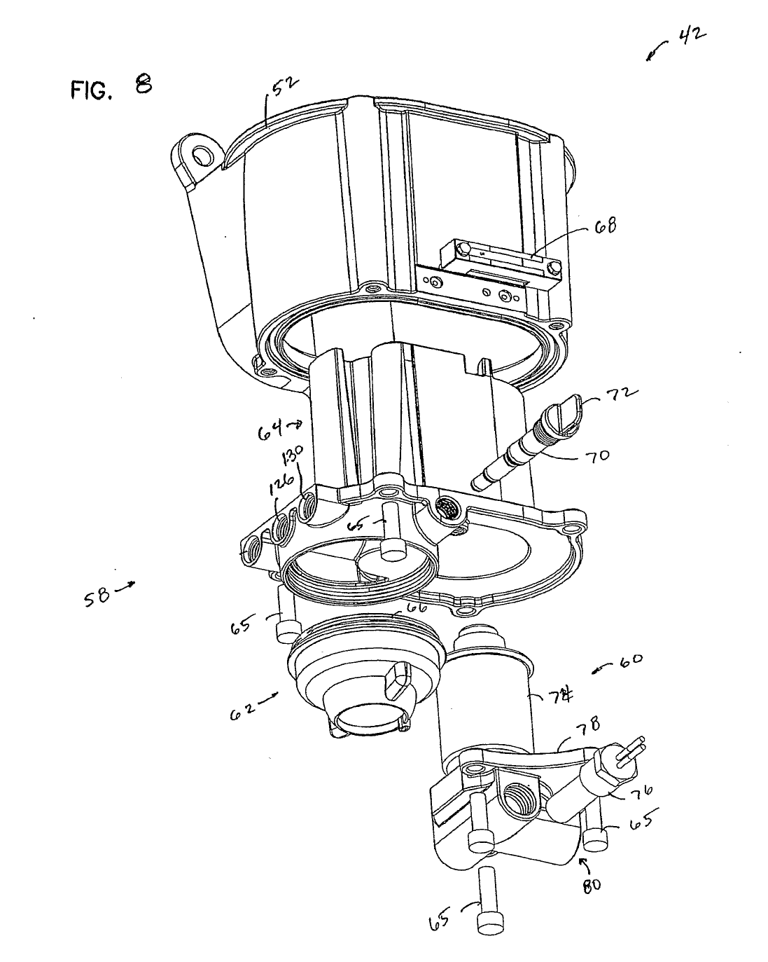

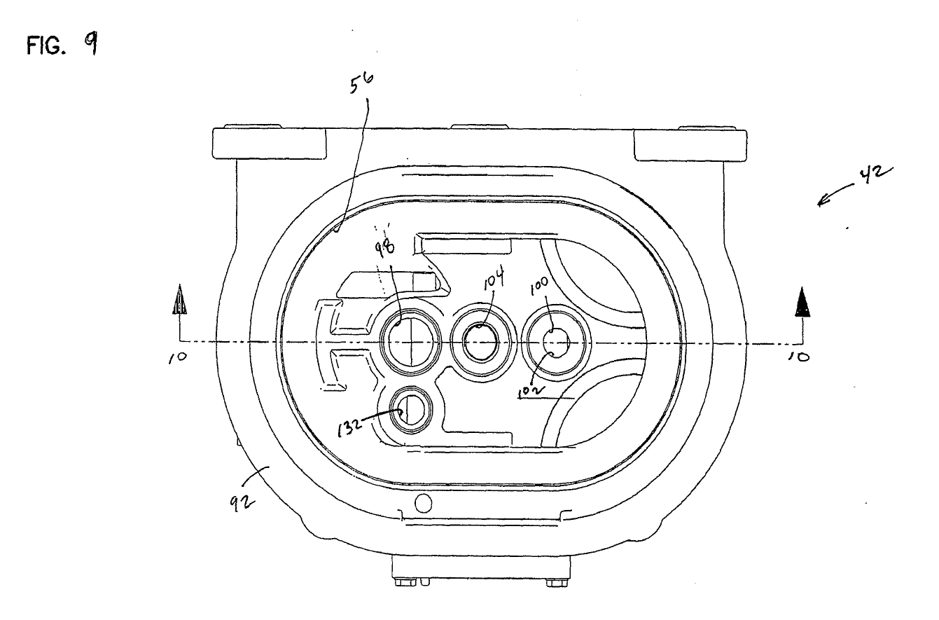

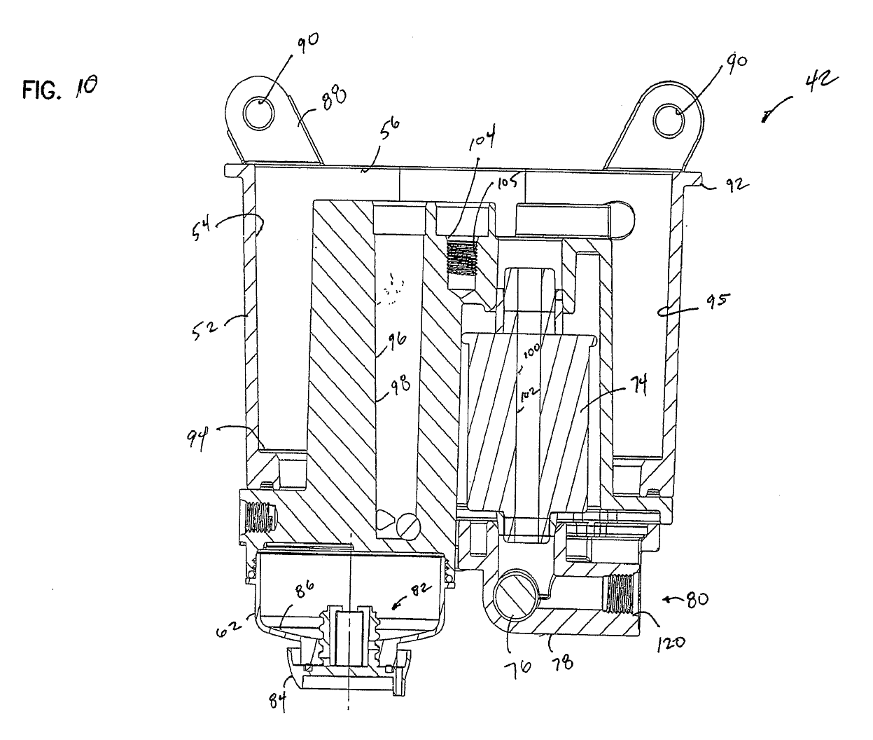

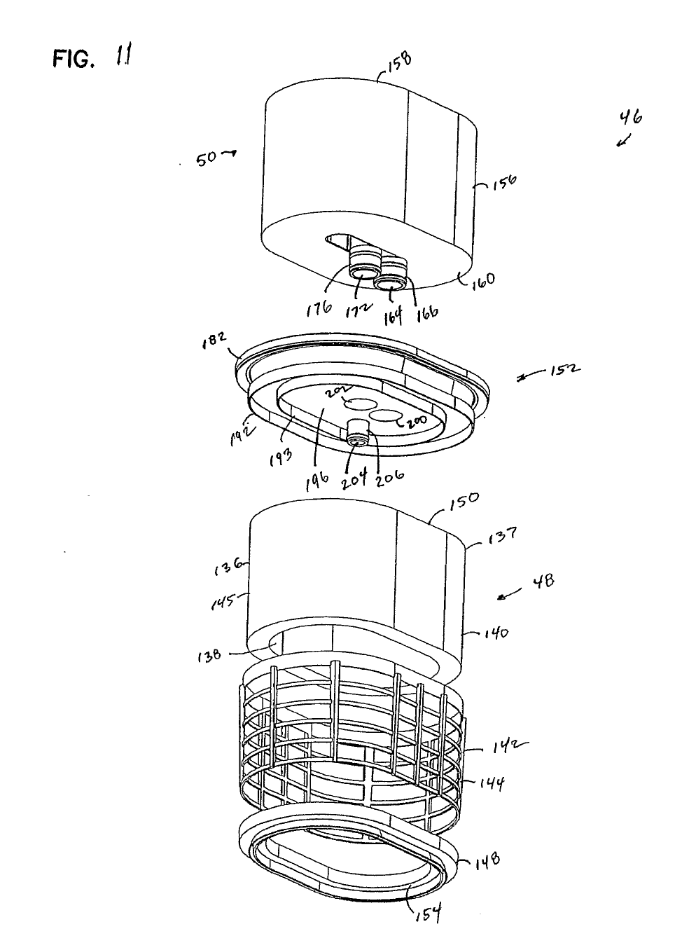

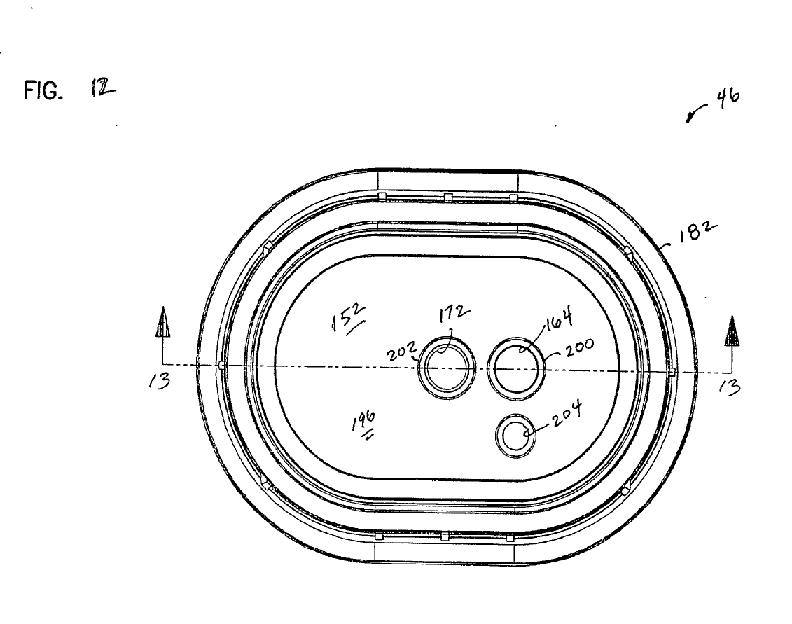

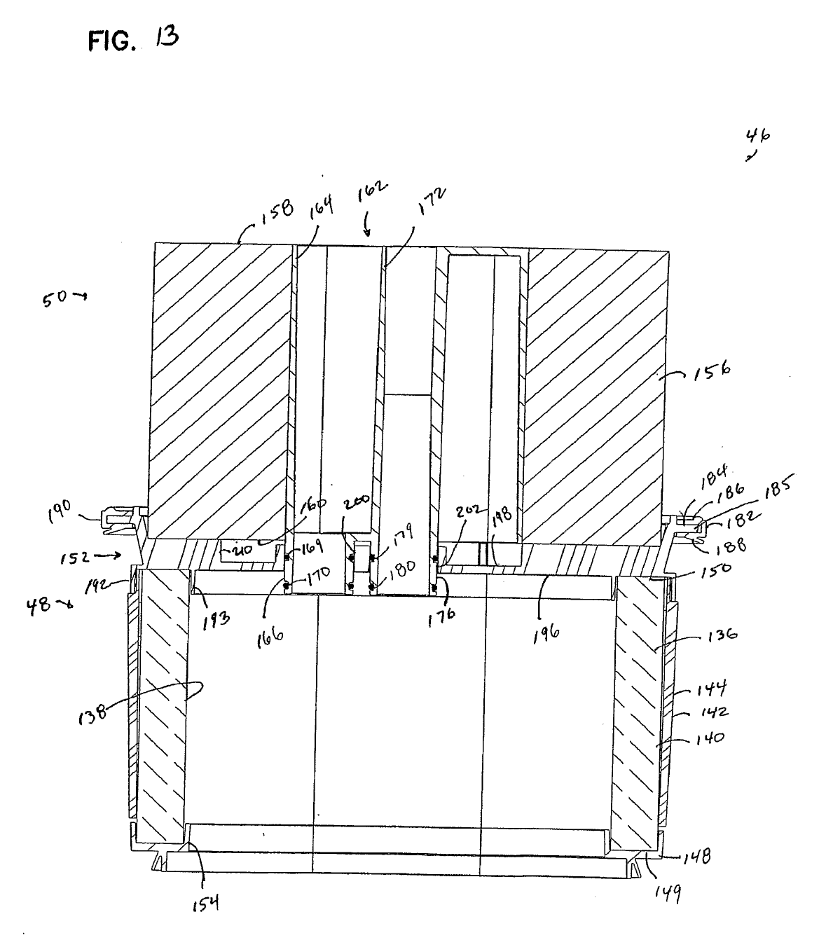

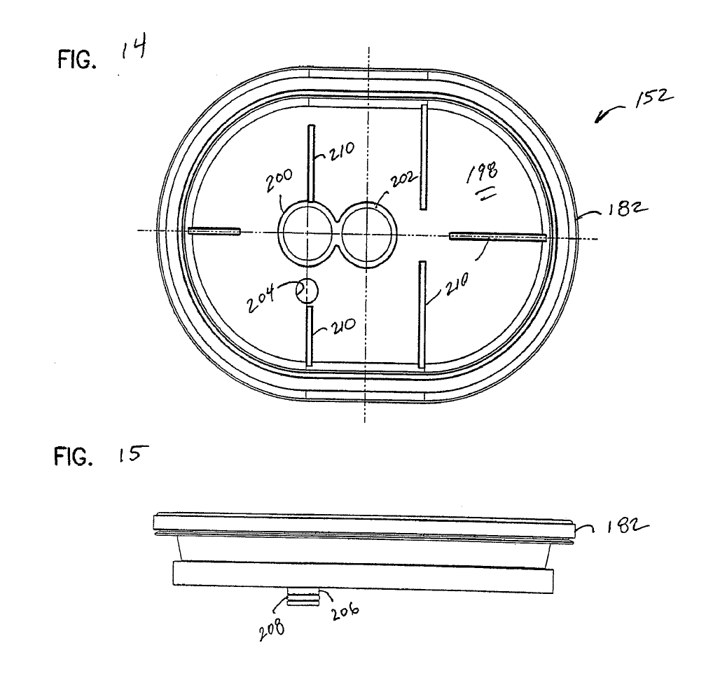

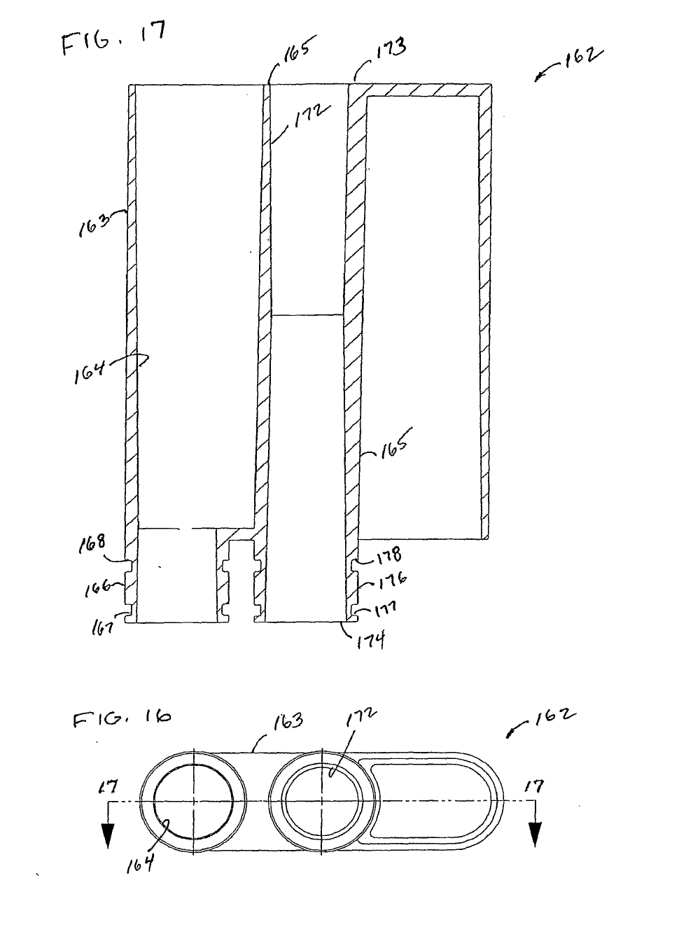

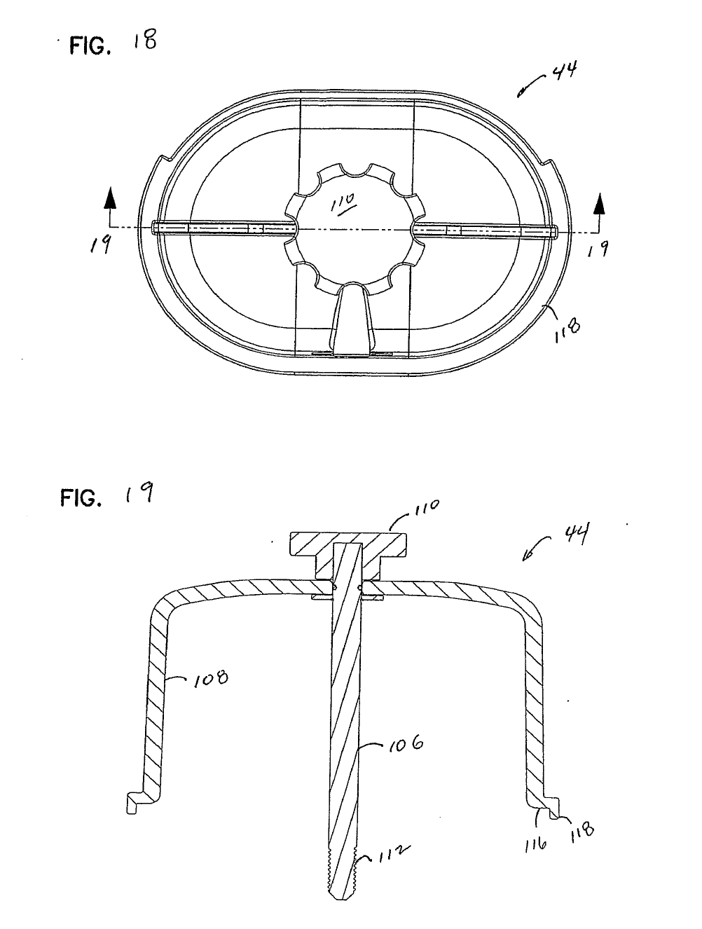

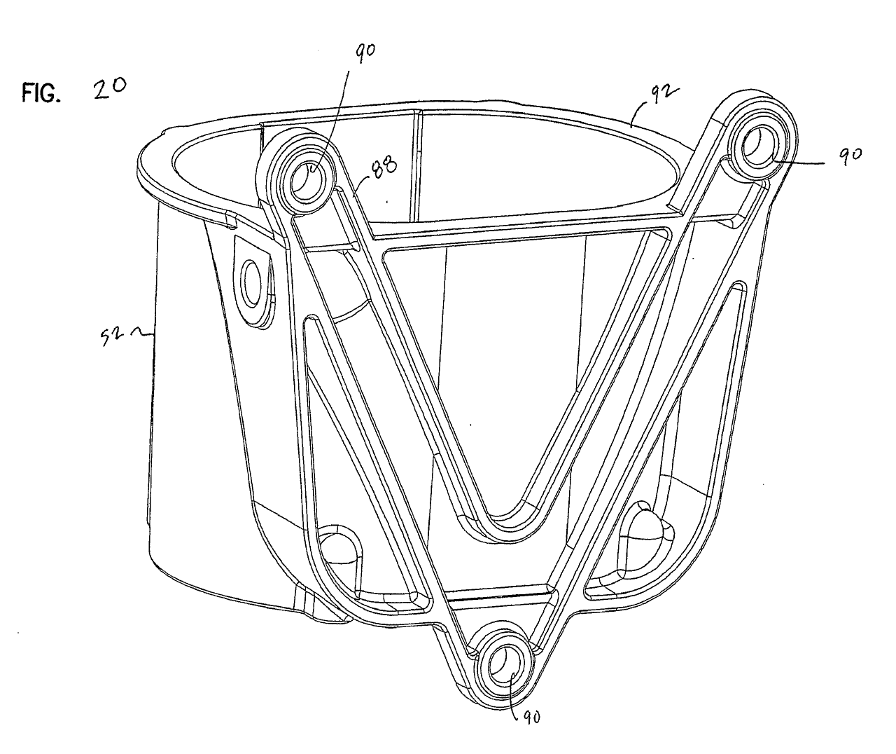

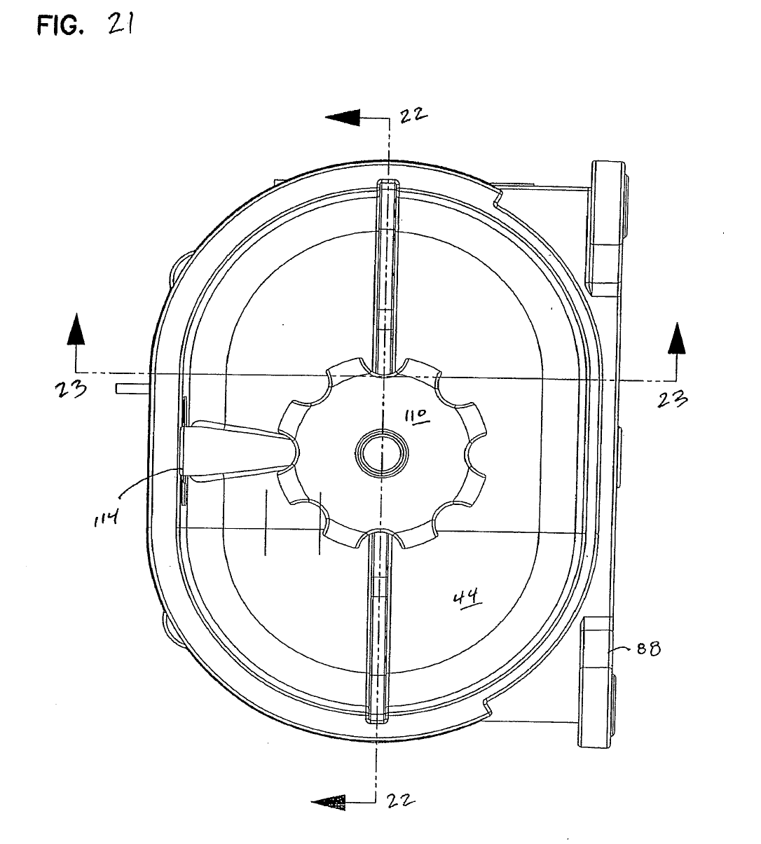

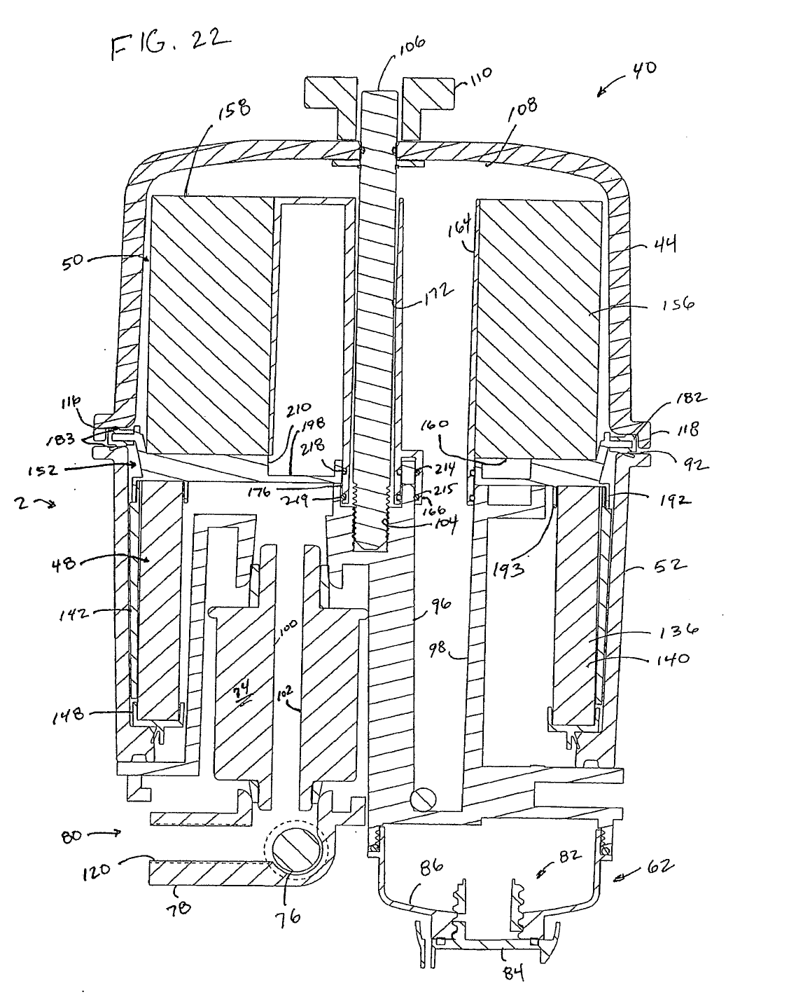

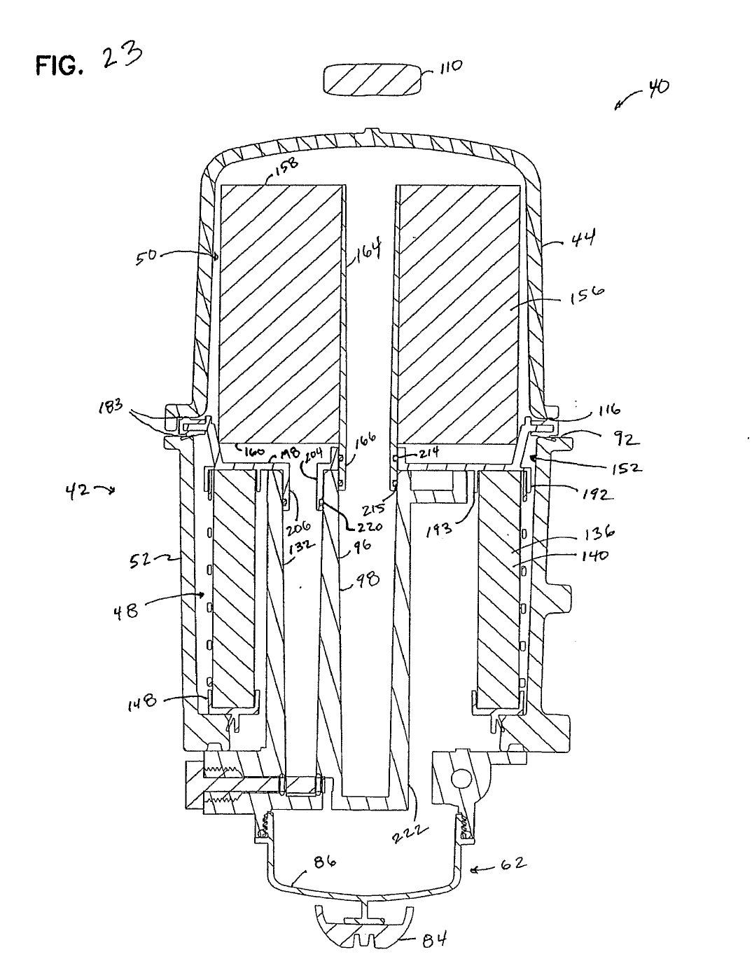

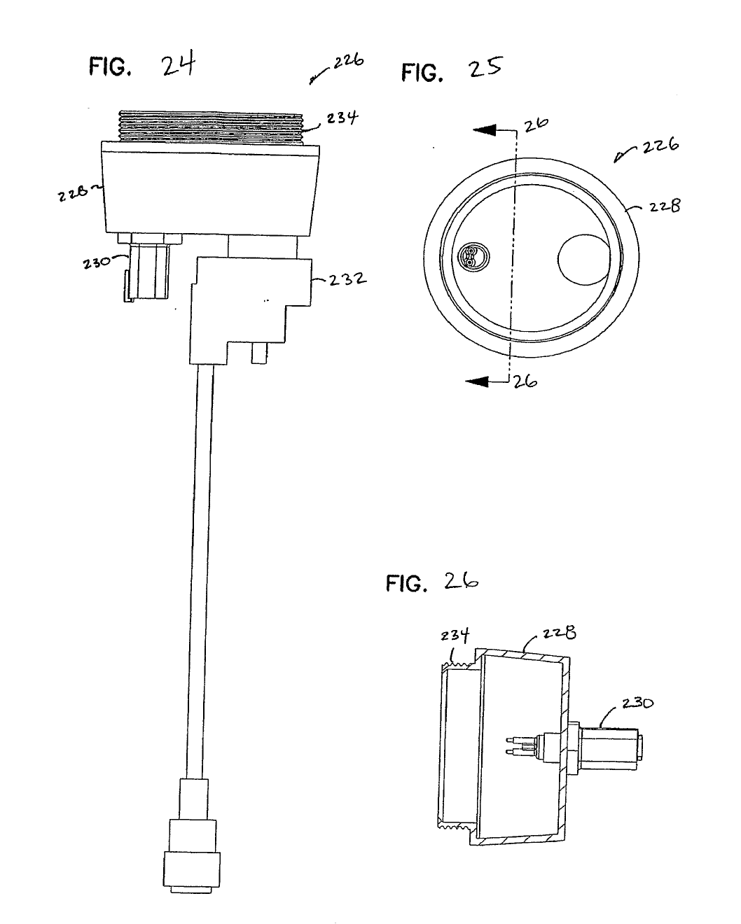

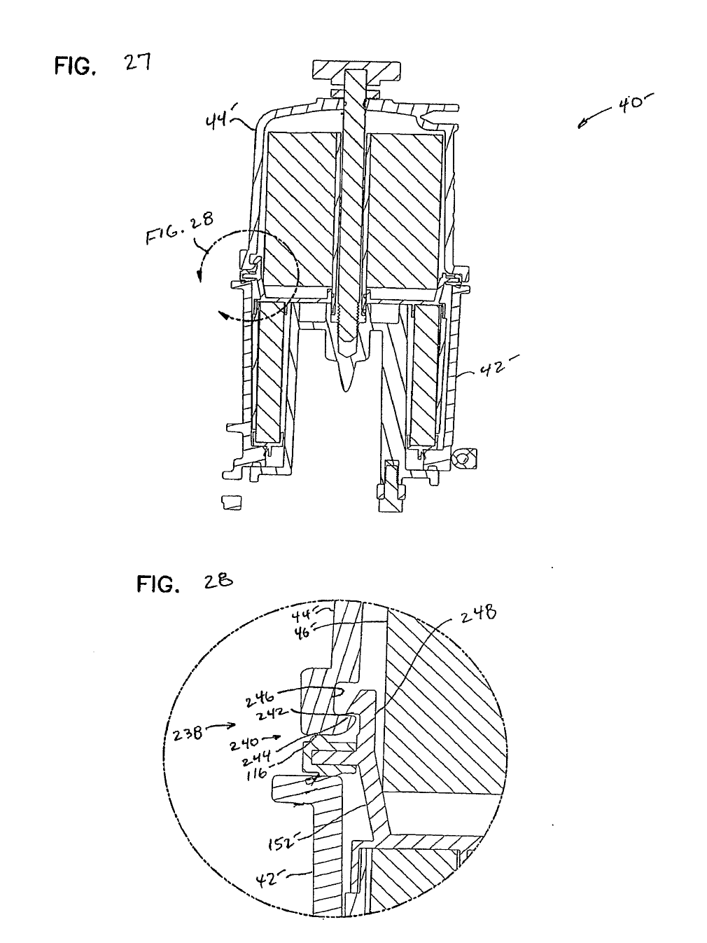

### A. Example Fuel Circuit System, FIG. 2

FIG. 2 depicts a schematic of a fuel circuit system 22. While a fuel system 22 is depicted, it should be understood that any system which utilizes a filter on a suction side of a pump and a filter on a pressurized side of a pump could be used. The fuel system 22 depicted is just one example.

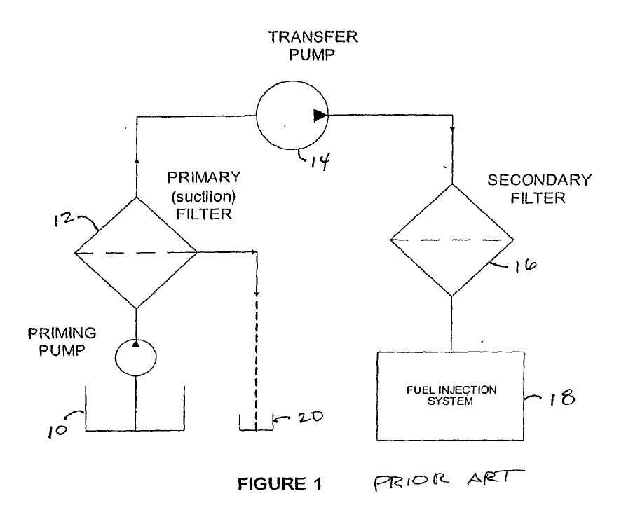

In FIG. 2, a suction or primary filter 24 is depicted on the suction side or upstream side of a pump arrangement 26, and a pressurized or secondary filter 28 is shown on the downstream side of the pump arrangement 26. The pump arrangement 26 can be a transfer pump, a primer pump, or a combination of both. If the pump arrangement 26 is only a transfer pump, then there will also be a primer pump 27 utilized upstream of the primary filter 24. In FIG. 2, the primary filter 24 and the secondary filter 28 are part of a single, unitary housing 30. In preferred embodiments, described further, the primary filter 24 and secondary filter 28 are combined together into a single filter element. The single filter element costs less to produce than two separate elements. In addition, the time it takes to service the single combined filter element is shorter than servicing two separate units, as shown in the prior art FIG. 1.

Still in reference to FIG. 2, the pump arrangement 26 is either a transfer pump or a primer pump. In many applications, both a transfer pump and primer pump are used. The transfer pump is mounted to the engine and is powered by mechanical means (usually a set of gears) to the drive shaft of the engine. The primer pump is usually mounted to the filter element and is used specifically to prime the system after a filter has been replaced. Air is trapped in the fuel system after a filter has been replaced, and the primer pump is used to prime the fuel system. Because the transfer pump is driven by the engine, it could take several minutes of turning the engine over off of the battery to get the fuel system primed enough to start the engine. In FIG. 2, an electric drive transfer pump could be used as the pump arrangement 26, eliminating the need for a separate primer pump. The electric drive transfer pump could also be used to prime the system without the need to turn the engine over.

Also depicted in FIG. 2 is a fuel tank 32, a drain assembly 34, and a fuel injection system 36. The pump arrangement 26 draws fuel from the fuel tank 32 and into the primary filter 24. The primary filter 24 removes at least some water from the fuel. The water drains to the drain assembly 34. The primary filter 24 also removes at least some particulate material from the fuel. The filtered fuel is then pushed by the pump arrangement 26 through the secondary filter 28. The secondary filter 28 filters the fuel before the fuel is conveyed to the fuel injection system 36.

### B. Example Embodiment of Filter Arrangement, FIGS. 3-10, 22, and 23

FIG. 3 depicts an exploded perspective view of one embodiment of a filter arrangement 40. The filter arrangement 40 is useable in the fuel system 22 of FIG. 2, but it could also be used in other types of systems. In FIG. 3, a housing 42 with a removable cover 44 is shown containing a filter element 46. The filter element 46 is shown partially removed from the housing 42, and the cover 44 is shown removed from both the housing 42 and the filter element 46.

The filter element 46, in the embodiment shown, generally includes a first media construction 48 and a second media construction 50. As can be seen in FIG. 3, in the embodiment shown, the first media construction 48 and the second media construction 50 are axially aligned; that is, they are stacked one on top of the other. In the embodiment shown, the second media construction 50 is shown stacked on top of the first media construction 48. Obviously, the filter element 46 can be oriented in space in any orientation and still have the first and second media constructions 48, 50 be axially aligned.

In reference now to FIGS. 3-8, 20, 22, and 23, the housing 42 and various internal components are described. The housing 42 includes an exterior wall 52 defining a housing interior 54. The housing 42 has an access opening 56, which allows the filter element 46 to be inserted and removed. When the cover 44 is removed from the housing 42, the access opening 56 is exposed, exposing the filter element 46.

The housing 42 includes, in the embodiment shown, internal components 58 (FIG. 8). Internal components 58 include, in the embodiment shown, a pump arrangement 60, a bowl 62, and lower housing 64. As the term “housing 42” is used herein, it can mean the assembly of outer housing wall 52, pump arrangement 60, bowl 62, and lower housing 64, or any subcombination of these parts.

The lower housing 64 is received within the exterior wall 52, and the wall 52 and lower housing 64 are secured together by fasteners, such as screws 65. The bowl 62 is threadably secured to the lower housing 64 by threads 66.

A restriction indicator 68 is shown mounted through the wall 52 of the housing 64 to provide an indication of restriction across the first media construction 48, in this case, the primary filter.

A drain plunger assembly 70 having a thumb knob 72 is depicted as being mounted and threadably rotatable through the lower housing 64. The drain plunger assembly 70 opens ports that allow the first and second media constructions 48, 50 to drain fuel back into the fuel tank 32 when servicing the filter arrangement 40.

The bowl 62 collects water that is separated from the fuel by the primary filter 48. The bowl 62 includes a drain valve assembly 82 (FIG. 10) constructed, in the illustrated embodiment, according to commonly assigned pending U.S. patent application Ser. No. 11/202,736, filed Aug. 11, 2005, which application is incorporated herein by reference. In FIG. 10, the bowl 62 can be seen in cross-section along with a drain valve assembly 82. The drain valve assembly 82, as described in incorporated application Ser. No. 11/202,736, includes a knob 84, which is rotatable relative to the bowl 62. The bowl 62 has a water collection chamber 86, and upon rotation of the knob 84, channels will align and open to allow drainage of the water from the water collection region 86 and through the drain valve assembly 82.

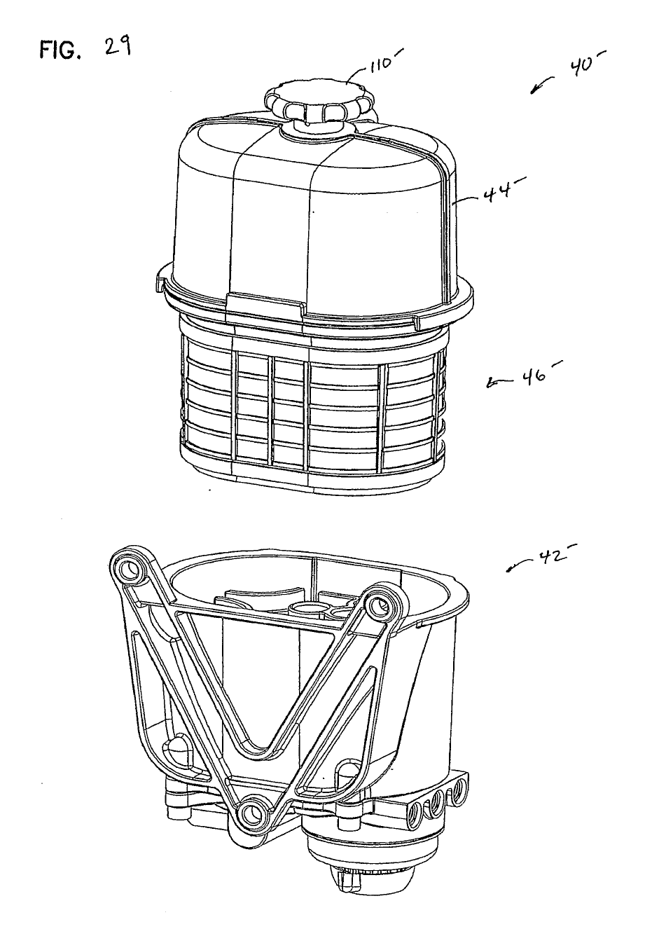

FIGS. 24-26 show an alternative embodiment of a bowl and drain assembly at reference numeral 226. The bowl and drain valve assembly 226 includes bowl 228, sensor 230, and automatic drain with electrical connector 232. If one does not wish to manually drain the water from the bowl 62, as shown in FIG. 10, the arrangement in FIGS. 24-26 is useable. The water collects in the bowl 228, and the water sensor 230 senses the level of water collected in the bowl 228. Periodically, when the level of water is sufficiently high, it warrants the automatic water drain with the electrical connector 232 to activate and drain the water from the bowl 228. As can be seen in FIGS. 24 and 26, the bowl 228 has a threaded connection 234 to allow the bowl 228 to be easily connected to the lower housing 64.

In reference again to FIG. 8, the pump arrangement is shown at 60. As mentioned above, the pump arrangement 60 can be a primer pump, a transfer pump, or a combination of both. In the example embodiment illustrated, the pump arrangement 60 operates as a primer pump 74. A heater 76 is operably held by a bracket 78. The bracket 78 holds the primer pump 74 and the heater 76. The heater 76 warms up the fuel as it is conveyed from the fuel tank 32 (FIG. 2) into the housing 42. The bracket 78 defines an inlet arrangement 80, seen more clearly in FIGS. 1, 5, and 22, such that fuel from the fuel tank 32 is conveyed through the bracket 78 and heated by the heater 76. The heating of the fuel is helpful when the fuel is diesel fuel.

In FIG. 20, the portion of the housing 42 comprising the wall 52 is depicted. In the view in FIG. 20, it can be seen how the surrounding wall 52 has an integral flange 88, in the embodiment shown, in the shape of a V. The flange 88 defines apertures 90 for accepting fasteners, such as bolts, to secure the overall filter arrangement 40 to the vehicle. In FIGS. 20 and 10, it can be seen how the surrounding wall 52 defines an outer surrounding rim 92. In preferred embodiments, the rim 92 functions to receive a seal member to form a seal with the cover 44. This is described further below.

In reference now to FIG. 10, other features visible in FIG. 10 include a seat 94 for the first media construction 48 to occupy in volume 95. A fluid channel can be seen at 96, functioning as an inlet channel 98 for the second media construction 50. A fluid channel 100 passes through the primer pump 74 and functions as an inlet channel 102 for the first media construction 48. In the embodiment illustrated in FIG. 10, a threaded receiver or socket 104 is also part of the housing 42, and is defined in particular by the lower housing 64. The socket 104 threadably receives a bolt 106 (FIGS. 19 and 22) extending in an interior 108 of the cover 44.

In the embodiment shown in FIG. 19, the cover 44 includes a rotatable knob 110 secured to the bolt 106. The bolt 106 includes threads 112, which mate with the threads in the socket 104 (FIG. 10). The combination of the bolt 106 with the rotatable knob 110 and the socket 104 in the housing 42 allows for selective securing or locking and selective unsecuring or unlocking of the cover 44 to the housing 42. Other securing arrangements are useable, such as latches or other fasteners.

In reference again to FIG. 3, another feature in the depicted embodiment of the cover 44 includes an air or gas port 114. The gas port 114 assists with draining the filter arrangement 40, during servicing, to allow for the flow of air into the housing 42.

In reference now to FIGS. 3, 18, and 19, the cover 44 defines an outer flange 116 with an outer rim 118 adjacent to the flange 116. In use, the flange 116 will cooperate with a seal member 182 on the filter element 46 and form a seal 183 with the rim 92 of the housing 42. In the embodiment to be described further below, the seal 183 will be an axial, pinch seal between flange 116 and rim 92, with rim 118 functioning as a protectant. As can be seen in FIG. 18, the rim 118 extends only partially around the perimeter of the cover 44.

In FIG. 9 and FIG. 18, it can be appreciated that the housing 42 and the cover 44 are non-round in configuration. The cover 44, in the embodiment shown, is obround or generally oval. The access opening 56 in the housing 42 is generally the shape of the cover 44, and in the example shown, is generally oval or obround.

In reference again to FIGS. 3-10, the inlet and outlet arrangements in the housing 42 are now described. As mentioned above, an inlet arrangement 80 comprises a primary inlet port 120 (FIGS. 3, 5, 10, and 22). The primary inlet port 120 is in fluid flow communication with the primary filter inlet channel 102, and passes over the heater 76. The primary inlet port 120 is also in fluid flow communication with the fuel tank 32 (FIG. 2), such that fuel is drawn from the fuel tank 32, into the primary inlet port 120, over the heater 76, and into the primary filter inlet channel 102. From there, the fuel travels to the first media construction 48, to be described further below.

A primary outlet port is defined by the housing at 122 (FIGS. 3, 5, and 7). After the fuel passes through the first media construction 48, which will be situated in the seat 94 and in volume 95 (FIG. 10), the filtered fuel passes through the primary outlet port 122. In this embodiment, the fuel filtered by the first media construction 48 passes out of the housing 42 and to a transfer pump. In other embodiments, when the pump arrangement 60 (FIG. 8) operates as both a primer pump and transfer pump, then the filtered fuel will not need to exit the housing 42. FIGS. 22 and 23 show the first media construction operably installed in housing 42.

The housing 42 further includes a secondary inlet arrangement 124 (FIG. 6). In the embodiment shown, the secondary inlet arrangement 124 includes a secondary fluid inlet port 126. The secondary inlet port 126 is in fluid flow communication with the secondary inlet channel 98 (FIGS. 9 and 10). The fuel flows from the transfer pump through the secondary inlet port 126, into the secondary filter inlet channel 98 and to the secondary media construction 50, to be described further below.

The housing 42 further includes a secondary outlet arrangement 128 (FIG. 6). In the embodiment shown, the secondary outlet arrangement 128 includes a secondary outlet port 130 in fluid flow communication with a secondary outlet channel 132 (FIGS. 9 and 23). The fuel flows from the transfer pump, through the second inlet port 126, through the secondary filter channel 98, through the second media construction 50 (to be described further below), through the secondary outlet channel 132 (FIG. 23) and exits the housing through the secondary outlet port 130 (FIG. 6). From the secondary outlet port 130, the filtered fluid flows to the fuel injection system 36 (FIG. 2).

### C. Example Filter Element 46, FIGS. 3, 11-17, 22, and 23

The example filter element 46, as mentioned above, includes the first media construction 48 and the second media construction 50. As can be seen in FIG. 3, the filter element 46 is operably installable, removable, and replaceable from the housing 42.

FIG. 11 depicts an exploded view of the example filter element 46. The filter element 46 depicted includes the first media construction 48 including a first filter media 136 having a tubular shape 137. By “tubular shape”, it is meant that the first filter media has a closed perimeter with an open, hollow interior 138. The tubular shape 137 can be generally cylindrical or non-cylindrical. In the embodiment shown, the tubular shape 137 of the first filter media 136 is non-round, and in particular, obround or oval. Many different types of filter media can be used for the first filter media 136, but in general, the media 136 is constructed for radial flow therethrough. One useable type of media for radial flow is pleated media 140. The pleated media 140 preferably will include a media with a hydrophobic coating to separate water from fuel that is passing through the first media construction 48. In other types of systems, other types of media will be used, as selected by the filter engineer.

The first media construction 48 further includes, in the embodiment shown, an outer liner 142 holding or supporting the first filter media 136. The outer liner 142 will help to prevent the pleats from collapsing, when pleated media 140 is used. The outer liner 142, in the embodiment shown, is generally a grid 144 that circumscribes the exterior 145 of the first filter media 136. In preferred embodiments, the exterior 145 will be the downstream side of the first filter media 136, as fluid to be filtered flows from the filter interior 138 through the first filter media 136.

The first media construction 48, in the embodiment shown, also includes a lower end cap 148. The lower end cap 148 secures the end 149 of the pleated media 140. The opposite end 150 is secured to an end cap construction 152, which is axially between the first media construction 48 and the second media construction 50. The lower end cap 148 is an open end cap defining opening 154. The opening 154 allows the first media construction 48 to be positionable over and around to circumscribe internal components 58 of the lower housing 64. That is, the opening 154 allows the first media construction 48 to be fitted over and around the internal components 58, such that the internal components 58 are positioned within the open filter interior 138.

The second media construction 50 is axially aligned with the first media construction 48, as mentioned above. The second media construction includes second filter media 156. While a number of different filter media are useable, in the embodiment shown, the second filter media 156 is configured for axial flow, with the inlets and the outlets being at opposite axial ends of the second filter media 156. In the arrangement shown, the second filter media 156 has an inlet end at axial end 158, and an outlet end at opposite axial end 160.

In the embodiment shown, the second filter media 156 has non-pleated media configured for axial fluid flow. Such media can include Z-filter media as described in, for example, U.S. Pat. No. 6,783,565, incorporated herein by reference. Alternatively, the media 156 can include a plurality of layers of a filtration material stacked or wound in a spiral, wherein each layer is separated by a screen, and opposite alternating axial ends are blocked with a closure. In the embodiment shown in FIG. 13, fluid to be cleaned, such as fuel on the downstream or pressurized side of the transfer pump, enters the housing through the secondary inlet port 126, travels through the secondary inlet channel 98 (FIGS. 9, 10, and 23), and is conveyed to the inlet end 158 of the second media construction 50. The fuel to be cleaned then flows through the non-closed, open axial ends of the media 156. The fluid flows through the media 156 and exits the non-closed, open axial ends at the outlet end 160. From there, the cleaned fuel is conveyed through the secondary outlet channel 132 (FIGS. 9 and 23) and out through the secondary outlet port 130.

The first media construction 48 and second media construction 50 are fluidly isolated from each other. By the term “fluidly isolated”, it is meant that fluid that flows through the first media construction 48 and the second media construction 50 is separated by, at least, filtration media, while the primary inlet port 120 and primary outlet port 122 are completely separated from the secondary inlet port 126 and secondary outlet port 130.

In the embodiment shown in FIG. 11, the second filter media 156 has a non-cylindrical shape. Specifically, in the embodiment shown, the shape is oval, obround, or racetrack-shaped. In general, the outer perimeter of the second filter media 156 has the same shape of the outer perimeter of the first filter media 136, although the overall sizes may differ.

The filter element 46 further includes, in preferred embodiments, a center core construction 162 (FIGS. 13, 16, and 17). The center core construction 162, in the embodiment shown, is circumscribed by the second filter media 156. In preferred arrangements, the center core construction 162 includes at least one fluid-conveying tubular member 164. In preferred embodiments, the fluid to be filtered, such as fuel on the pressurized side of a pump, is conveyed through the secondary inlet channel 98 (FIGS. 9 and 10), through the fluid conveying tubular member 164, and then to the inlet end 158 of the second filter media 156. As can be seen in FIGS. 11, 13, and 17, the fluid conveying tubular member 164 has a neck 166 at an end. The neck 166 defines grooves 167, 168 for holding seal members 169, 170 (FIG. 13) for forming seals with adjoining parts. In the case of groove 168 and seal member 169, a seal 214 (FIG. 23) is formed with the end cap construction 152, to be described further below. In the case of groove 167 and seal member 170, a seal 215 (FIG. 23) is formed with the secondary filter inlet channel 98 (FIGS. 9 and 10).

The fluid-conveying tubular member 164 forms a complete through hole or passage from end 173 to end 174 of the center core construction 162, in the embodiment shown.

In FIG. 17, the center core construction 162 generally has an outer wall 163 and internal walls 165 to help form the fluid-conveying tubular member 164. In addition to the fluid-conveying tubular member 164, in preferred embodiments, the center core construction 162 defines a handle-receiving tubular member 172 (FIGS. 17 and 22). The handle-receiving tubular member 172 defines a complete through hole from opposite axial ends 173 and 174. The handle-receiving tubular member 172 operably receives a handle, and as embodied herein, the bolt 106 (FIGS. 19 and 22) projecting from the cover 44. As depicted in the embodiment of FIG. 22, the bolt 106 is allowed to pass through the second media construction 50 by passing through the handle-receiving tubular member 172. The bolt 106 is then allowed to connect into the socket 104 of the housing 42.

The handle-receiving tubular member 172 includes a neck 176 extending at an end thereof The neck 176 defines a pair of grooves 177, 178, which receive seal members 179, 180 (FIG. 13). The seal member 179 forms a seal 218 (FIG. 22) between the center core construction 162 and the end cap construction 152, while the seal member 180 forms a seal 219 (FIG. 22) between the center core construction 162 and the socket 104 (FIG. 10).

As can be seen in FIG. 16, the center core construction 162 has a non-round perimeter, for example, an obround or racetrack-shaped perimeter. If other shapes for the second filter media 156 are desired, the shape of the center core construction 162 could be altered.

The filter element 46 further includes a seal member 182 circumscribing the first and second media constructions 48, 50. When the filter element 46 is operably installed within the housing 42, the seal member 182 forms a seal between the filter element 46, the housing wall 52, and the cover 44. In the example embodiment shown, the seal member 182 forms a pinch seal 183 (FIGS. 22 and 23) by axial compression between the cover 44 and the housing 42. In example embodiments, the seal member 182 can be made from rubber, compressible polyurethane foam, and other suitable materials. In preferred embodiments, the seal member 182 is held and supported by the end cap construction 152.

The end cap construction 152 is now described in further detail. A preferred embodiment of the end cap construction 152 is shown in FIGS. 11-15. The end cap construction 152 depicted includes an outer band 184 holding the seal member 182. In FIG. 13, it can be seen how the seal member, in cross-section, is U-shaped with a first side 186 and a second side 188 with a flange 185 of the outer band 184 between the first and second sides 186, 188. When the filter element 46 is operably installed in the housing 42, the flange 116 of the cover 44 engages the first side 186, while the rim 92 of the housing 44 engages the second side 188. The rim 118 covers the outer radial surface 190 of the seal member 182. When the knob 110 is turned, it turns the bolt 106 which engages the threads 105 in the socket 104 and moves the cover 44 axially towards the housing 42. This results in a compressive force between the flange 116, the first side 186 of the seal member 182 and the second side 188 of the seal member 182 with the rim 92 of the housing 42. The flange 185 of the end cap construction 152 holds to support the seal member 182 against these axial forces. This axial compression forms seal 183 with the seal member 182 between the cover 44 and the housing 42.

The end cap construction 152, in FIG. 11, defines a pair of walls 192, 193, which function to hold the end 150 of the pleated media 140. The wall 192 is generally an outer wall and circumscribes the wall 193. These walls support the end 150 of the pleated media 140, and can hold adhesive, or potting compound, or other types of ways to fasten and secure the pleat ends of the media 140 to the end cap construction 152.

FIG. 12 shows a bottom plan view of the filter element 46. In FIG. 12, certain features of the end cap construction 152 are viewable. In particular, the end cap construction 152 has a generally planar first surface 196 and an opposite second surface 198 (FIG. 14). The end cap construction 152 defines at least one hole 200 accommodating the at least one fluid-conveying tubular member 164 of the center core construction 162. In particular, the hole 200 accommodates the neck 166 of the core construction 162. As depicted in FIG. 13, the seal member 169 forms a radial seal 214 (FIG. 23) between the end cap construction 152 and the neck 166 through the hole 200.

In preferred embodiments, the end cap construction 152 further includes a hole 202 to accommodate the neck 176 of the handle-receiving tubular member 172. In FIGS. 13 and 22, it can be seen how the neck 176 of the tubular-receiving member 172 extends through the hole 202 and seal 218 is formed between seal member 179 and the end cap construction 152.

In preferred arrangements, the end cap construction 152 further includes at least one outlet hole 204 to convey fluid filtered by the second media construction 156. In the embodiment shown, the end cap construction 152 includes a tube 206 (FIGS. 11 and 23) extending from the planar first surface 196. The tube 206 defines the through hole 204 to convey fluid from the second surface 198 of the end cap 152 through the end cap 152. The tube 206 operably and removably connects to the second outlet channel 132 (FIGS. 9 and 23). In FIG. 15, it can be seen how the tube 206 holds a seal member 208 to form a releasable seal 220 (FIG. 23) between the tube 206 and the second outlet channel 132.

In reference now to FIGS. 13, 14, and 22, the end cap construction 152 further includes media standoffs 210. Media standoffs 210 support and hold the second filter media 156 over and above the second surface 198 of the end cap construction 152. This allows the filtered fluid to exit the downstream end 160 and be collected in the volume defined between the end 160 of the media 156 and the second surface 198. The filtered liquid that exits the downstream end 160 and is collected in this region, then flows through the hole 204, through the tube 206, to the second outlet channel 132, and out through the second outlet port 130. From there, it is used by the fuel injector system 36 (FIG. 2).

FIGS. 27-29 show an alternative embodiment of the filter arrangement 40, depicted generally at 40′. In the embodiment of FIGS. 27-29, the cover 44′ is removably connected to the filter element 46′. FIG. 29 depicts one step of servicing the filter arrangement 40′, when the cover 44′ is removed from the housing 42′, and the filter element 46′ is removed along with the cover 44′. FIG. 27 is a cross-sectional view of the filter arrangement 40′, and FIG. 28 shows an enlarged view of the removable connection 238 between the filter element 46′ and the cover 44′. In particular, there is a latching mechanism 240 between the end cap construction 152′ and the cover 44′. The end cap construction 152′ has a hook 242 that engages a corresponding catch 244 on the cover 44′. The cover 44′ defines a U-shaped pocket 246 which forms the catch 244. The hook 242 engages the catch 244 in the pocket 246, and the hook is part of a deflectable flange 248. This engage between the element 46′ and cover 44′ allows the element 46′ to be removed with the cover 44′ during servicing. Then, the element 44′ can be removed from the cover 44′ by deflecting the flange 248 to disengage the hook 242 and catch 244.

### D. Methods

The filter arrangement 40 can be used to filter a variety of fluids. The fluids can be any type of system in which there is a filter upstream of a pump and a filter downstream of a pump. The example embodiment illustrated is for a fuel system. To filter fuel in a fuel system, the fuel is drawn from fuel tank 32 to primary filter 24 where water is separated and at least some particulate is removed. In the example shown, the fuel enters the filter arrangement 40 through the primary inlet port 120, where it is conveyed through the inlet channel 102. From there, it flows into the open filter interior 138 of the first filter media 136. Water is separated from the fuel by the filter media 136. The water drains downwardly through channel 222 (FIG. 23) and is collected in the bowl 62 in the water collection region 86. The drain valve assembly 82 can be opened to remove the water from the filter arrangement 40. Alternatively, as depicted in FIGS. 24-26, an automatic drain valve assembly 226 can be utilized, in which the water sensor 230 will detect when it is time to remove the water from the filter arrangement 40, and the automatic water drain valve 232 will activate to remove the water from the filter arrangement 40.

The fuel passes through the filter media 136 and then is drawn through the primary outlet port 122. From there, the fuel passes through the transfer pump and then is pushed through the secondary inlet port 126. The fuel passes from the secondary inlet port 126 through the secondary inlet channel 98, through the fluid conveying tubular member 164, and to the upstream side 158 of the second filter media 156. From there, the fuel flows axially through the media 156 and exits downwardly through the outlet end 160. The filtered fuel then collects in the region between the outlet end 160 and the second surface 198 of the end cap construction 152. The filtered fuel then flows through the hole 204 of the outlet tube 206 and then through the second outlet channel 132. From there, the fuel exits the housing 42 through the second outlet port 130. The filtered fuel then is used by the fuel injector system 36.

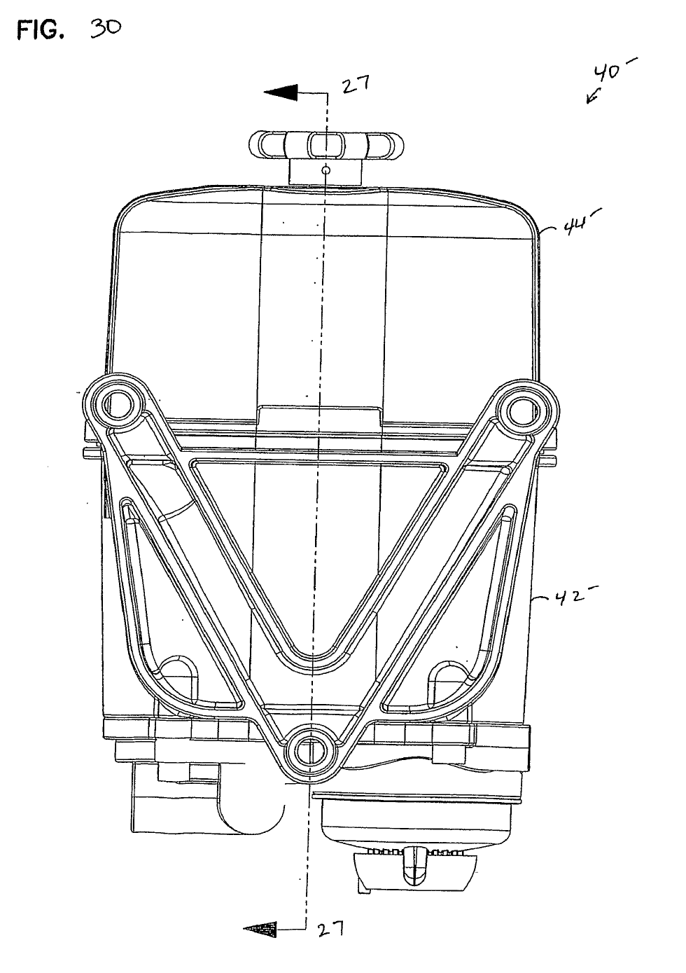

Periodically, the filter arrangement 40 will need servicing. To service the filter arrangement 40, the cover 44 is removed from the housing 42 and the filter element 46 is removed from the housing 42. The step of removing the filter element from the housing includes removing, simultaneously, the primary filter and the secondary filter, in the embodiment shown, the first media construction 48 and the second media construction 50. The step of removing the filter element 46 from the housing 42 can include either removing the cover 44 (44′) and element 46 (46′) in a single step (as depicted in FIGS. 27-30) or in separate steps, in which the cover 44 is removed from the housing 42 to expose the element 46, and then the element 46 is removed from the housing 42.

The step of removing the cover 44 includes rotating the knob 110 to turn the bolt 106, which will back the cover 44 axially off of the housing 42. This releases the compression between the cover 44 and the housing 42, which releases the seal 183 between the rim 116 (116′) of the cover 44, the seal member 182, and the rim 92 of the housing 42. When the knob 110 is turned, the bolt 106 is rotated, and extends through the second media construction 50 into the receiver or socket 104 in the housing 42. This will release the axial seal between the cover 44 and the housing 42.

As described above, the cover 44 (44′) can be removed with the filter element 46 (46′) attached, or it can be removed in a separate step. When the filter element 46 is removed from the housing 42, the first media construction 48 is removed from around the pump arrangement 60 and from around internal components 58 including fluid channels 98, 102, and 132. The filter element 46 is then discarded and replaced with a new filter element 46. If using the embodiment of FIGS. 27-30, the filter element 46′ is disengaged from the cover 44′ and then discarded. The new filter element 46 is operably installed in the housing 42 by passing it through the opening 56 and orienting the open filter interior 138 around to circumscribe the pump arrangement 60 and internal components 58, including fluid channels 98, 102, and 132. The first media construction 48 is operably oriented within the filter seat 94. The second side 188 of the seal member 182 is seated against the rim 92 of the housing 42.

During the step of operably orienting the filter element 46 in the housing 42, connections are made between the fluid conveying tubular member 164 and the secondary filter inlet channel 98 using seal member 170 to form seal 215. Also, a connection is made between the handle-receiving tubular member 172 and the socket 104 with the seal member 180 to form seal 219. In addition, a connection is made between the tube 206 and the second outlet channel 132 with the seal member 208 to form seal 220.

The cover 44 is operably oriented over the filter element 46. The cover 44 is placed over the second media construction 50. The flange 116 of the cover 44 is seated against the second side 188 of the seal member 182. The knob 110 is rotated to cause threaded engagement between threads 112 on the bolt 106 and threads 105 within the socket 104. This moves the cover axially against the housing 42 to cause compression of the seal member 182 between the flange 116 and the rim 92 to form axial seal 183.

When the embodiment of FIGS. 27-30 is utilized, the filter element 46′ can be first connected to the cover 44′ by engaging the hook 242 of the element 46′ into the catch 244 of the cover 44′, and then the assembly of the cover 44′ and element 46′ is operably installed within the housing 42′. Alternatively, in either the embodiment of FIGS. 1-23 or in the embodiment of FIGS. 27-29, the filter element 46 is installed into the housing 42 in a first step, followed by the separate installation of the cover 44 over the element 46.

The filter arrangement 40 should now be useable for filtering operation.

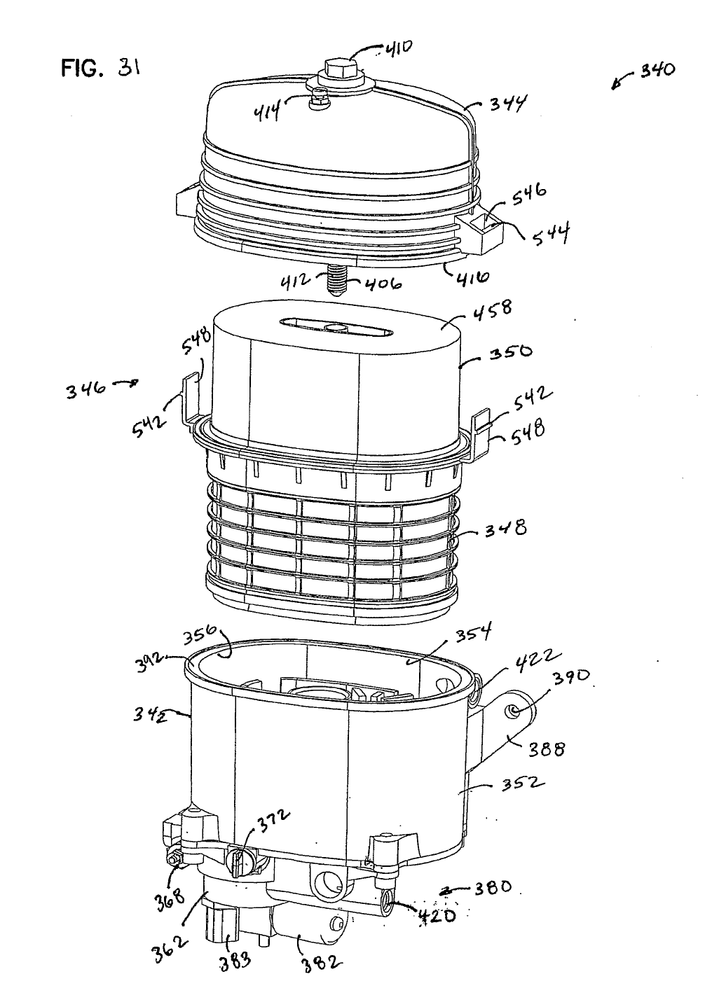

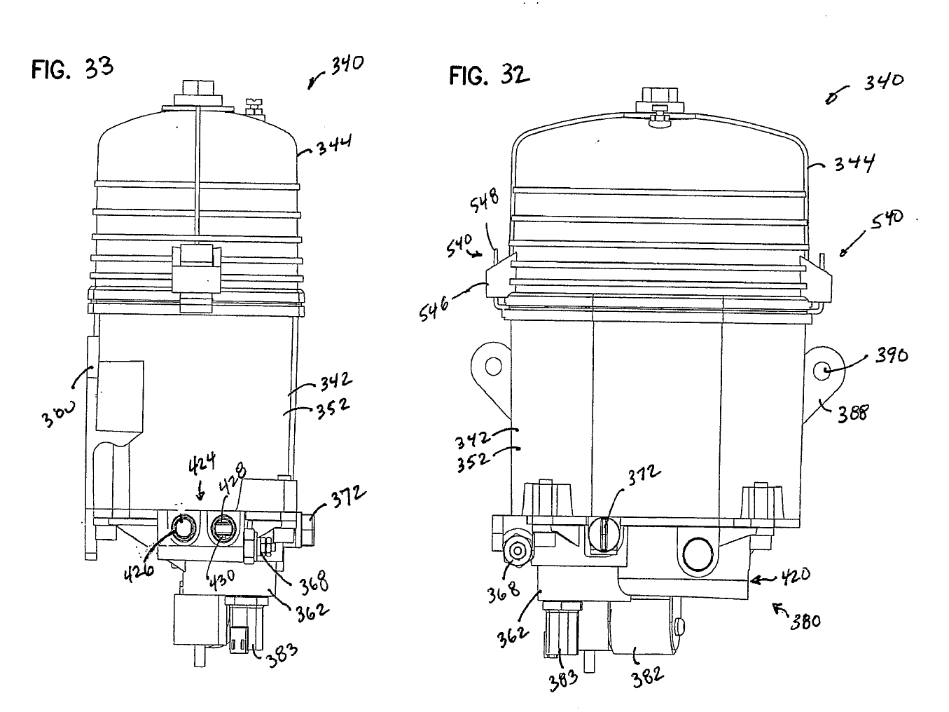

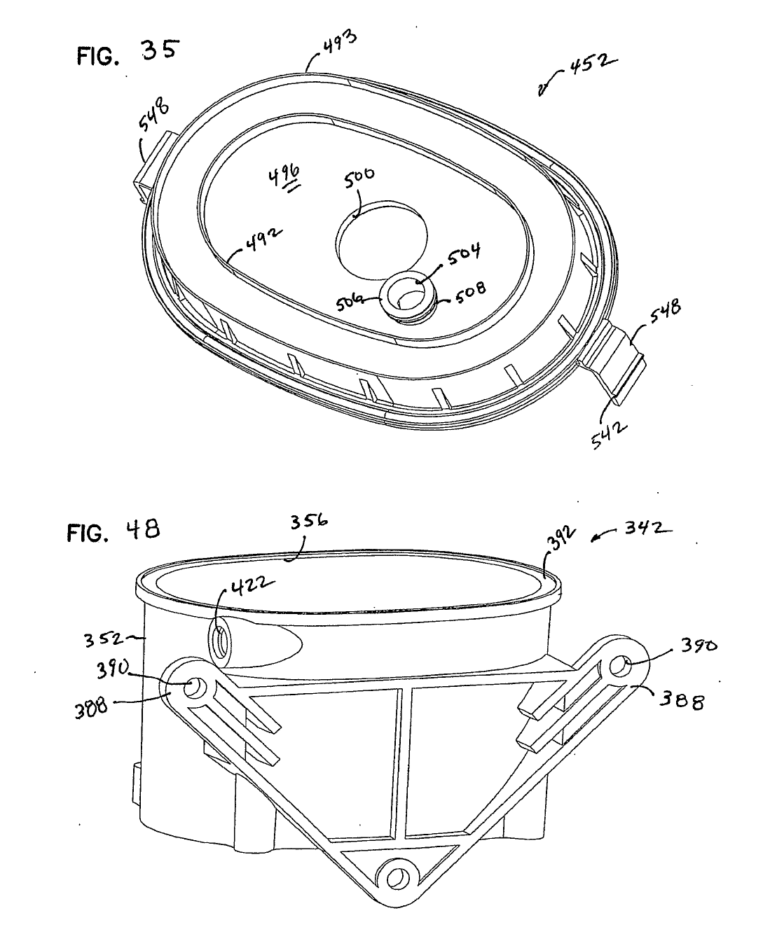

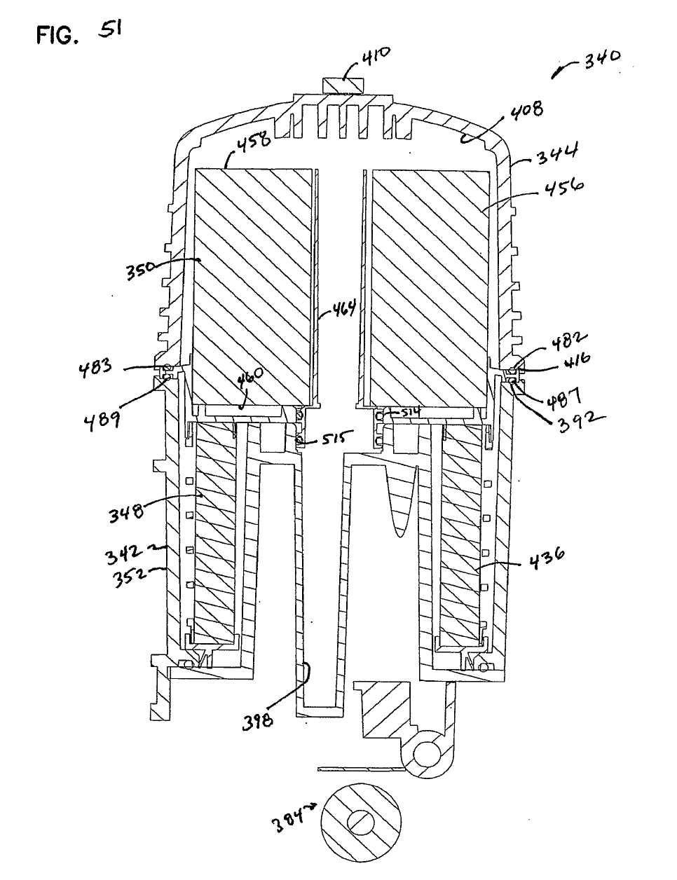

### E. Another Example Embodiment of Filter Arrangement, FIGS. 31-54

FIG. 31 depicts an exploded perspective view of another embodiment of a filter arrangement 340. The filter arrangement 340 is useable in the fuel system 22 of FIG. 2, but it could also be used in other types of systems. In FIG. 31, a housing 342 with a removable cover 344 is shown containing a filter element 346. The filter element 346 is shown removed from the housing 342, and the cover 344 is shown removed from both the housing 342 and the filter element 346.

The filter element 346, in the embodiment shown, generally includes a first media construction 348 and a second media construction 350. As can be seen in FIG. 31, in the embodiment shown, the first media construction 348 and the second media construction 350 are axially aligned; that is, they are stacked one on top of the other. In the embodiment shown, the second media construction 350 is shown stacked on top of the first media construction 348. Obviously, the filter element 346 can be oriented in space in any orientation and still have the first and second media constructions 348, 350 be axially aligned.

In reference now to FIGS. 31-38, the housing 342 and various internal components are described. The housing 342 includes an exterior wall 352 defining a housing interior 354. The housing 342 has an access opening 356, which allows the filter element 346 to be inserted and removed. When the cover 344 is removed from the housing 342, the access opening 356 is exposed, exposing the filter element 346.

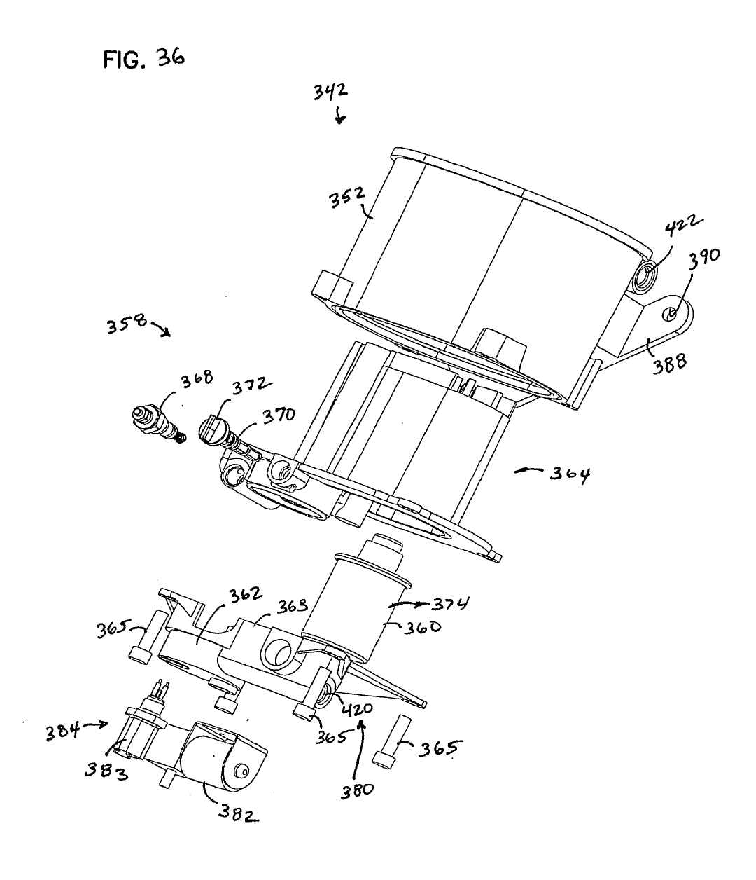

The housing 342 includes, in the embodiment shown, internal components 358 (FIG. 36). Internal components 358 include, in the embodiment shown, a pump arrangement 360, a bowl 362, lower housing 364, and water sensor and valve assembly 384. As the term “housing 342” is used herein, it can mean the assembly of outer housing wall 352, pump arrangement 360, bowl 362, lower housing 364, and assembly 384 or any subcombination of these parts.

The lower housing 364 is received within the exterior wall 352, and the wall 352 and lower housing 364 are secured together by fasteners, such as bolts 365. The bowl 362 is part of a casting 363 that is secured to the lower housing 364 and wall 352 with the bolts 365.

A drain plunger assembly 370 having a thumb knob 372 is depicted as being mounted and threadably rotatable through the lower housing 364. The drain plunger assembly 370 opens ports that allow the first and second media constructions 348, 350 to drain fuel back into the fuel tank (FIG. 2) when servicing the filter arrangement 340. A pressure switch 368 is adjacent to the plunger assembly 370.

The bowl 362 collects water that is separated from the fuel by the primary filter 348. The bowl 362 has a water collection chamber 386. The water sensor and valve assembly 384 is in communication with the collection chamber 386. Assembly 384 includes a water drain solenoid valve 382 and a water sensor 383. Together, these components help to drain water collected from fuel by the primary filter 384.

In reference again to FIG. 36, the pump arrangement is shown at 360. As mentioned above, the pump arrangement 360 can be a primer pump, a transfer pump, or a combination of both. In the example embodiment illustrated, the pump arrangement 360 operates as a primer pump 374.

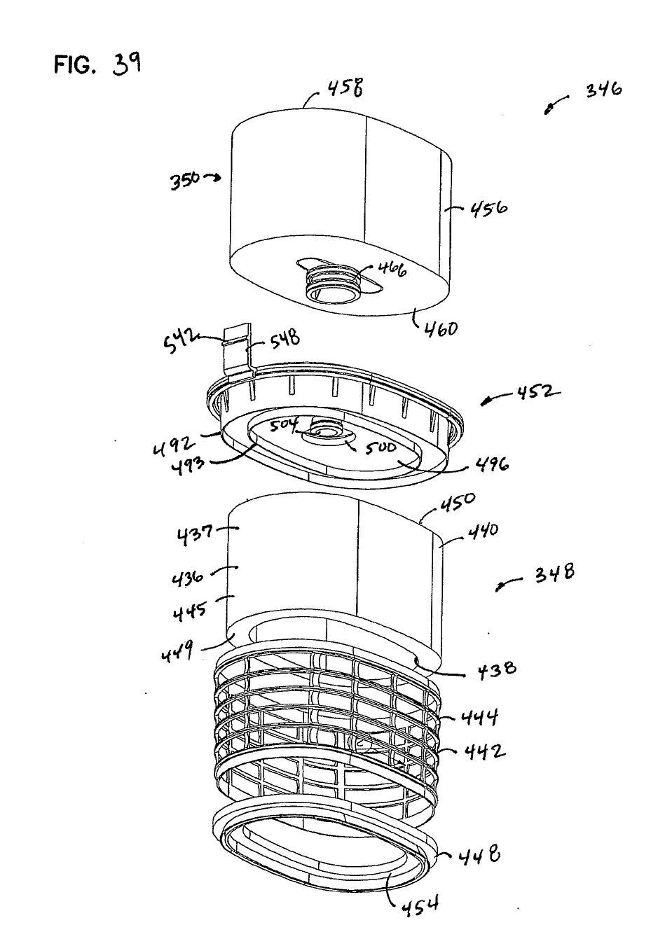

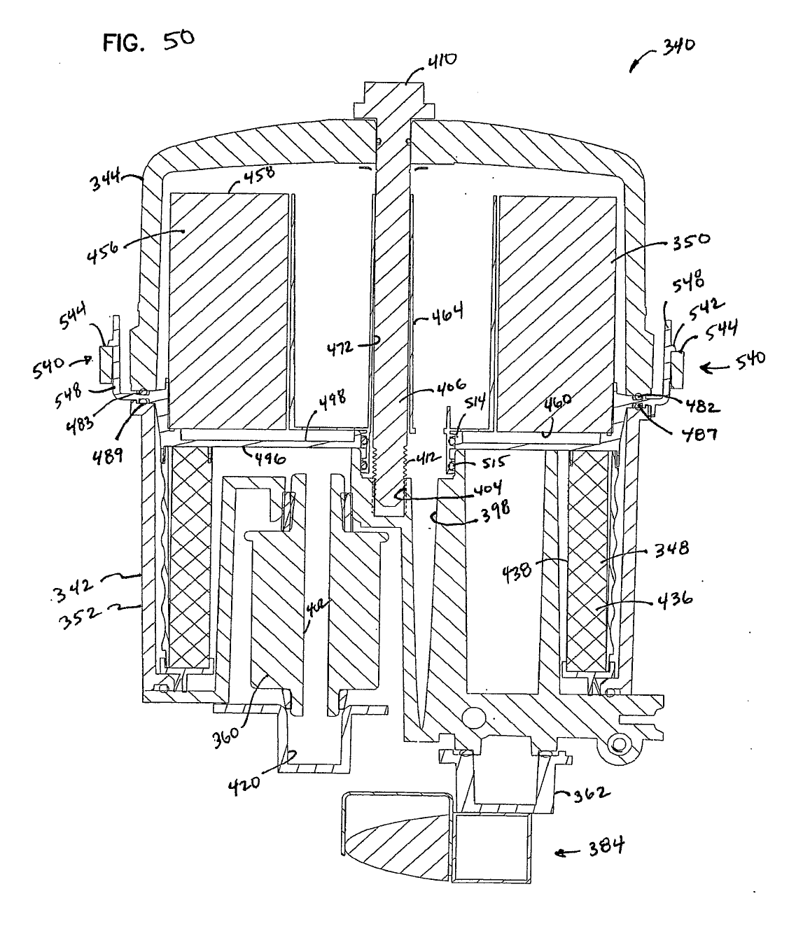

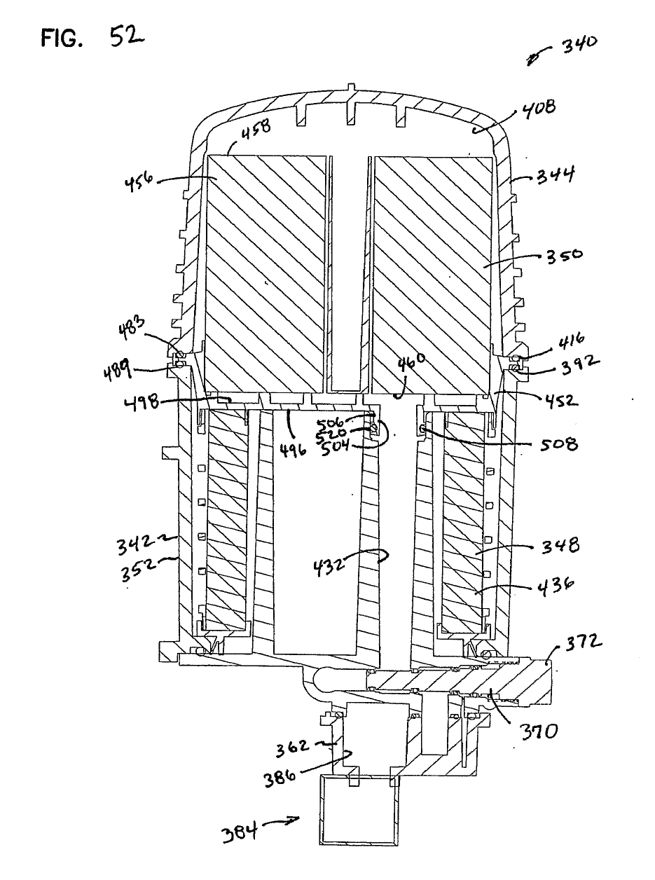

In FIG. 48, the portion of the housing 342 comprising the wall 352 is depicted. In the view in FIG. 48, it can be seen how the surrounding wall 352 has an integral flange 388, in the embodiment shown, in the shape of a V. The flange 388 defines apertures 390 for accepting fasteners, such as bolts, to secure the overall filter arrangement 340 to the vehicle. In FIGS. 48 and 38, it can be seen how the surrounding wall 352 defines an outer surrounding rim 392. In preferred embodiments, the rim 392 functions to receive a seal member 487 to form a seal 489 (FIG. 50) with the cover 344. This is described further below.

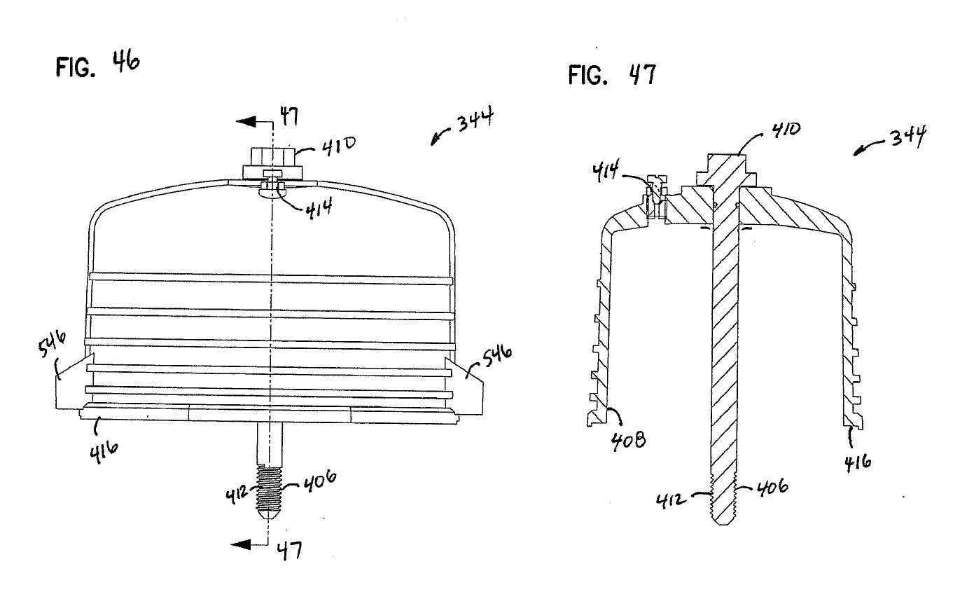

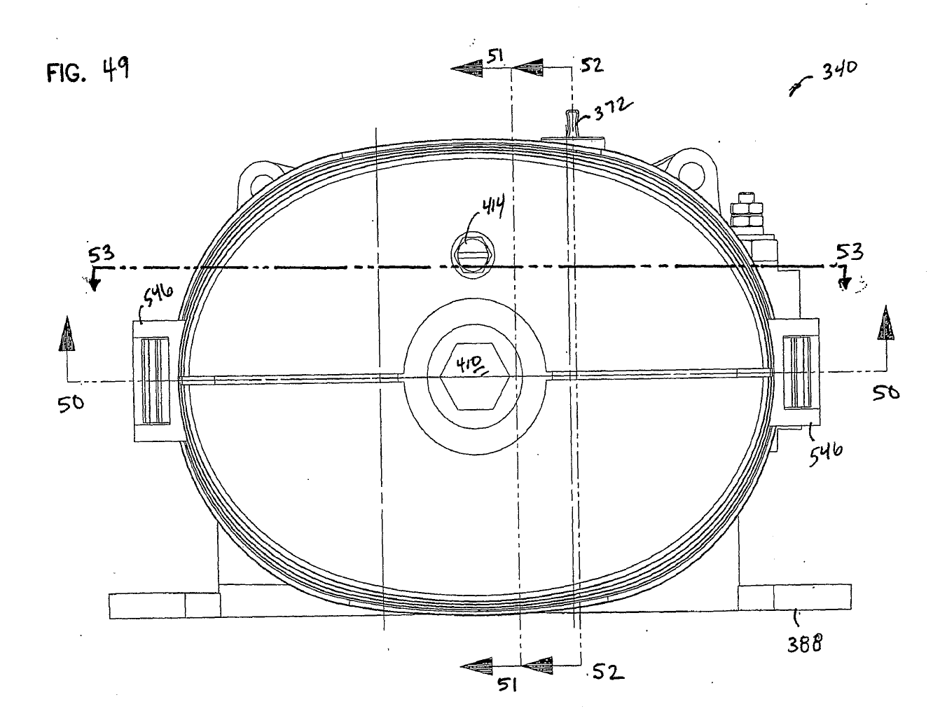

In reference now to FIG. 38, other features visible in FIG. 38 include a seat 394 for the first media construction 348 to occupy in volume 395. A fluid channel can be seen at 396, functioning as an inlet channel 398 for the second media construction 350. A fluid channel 400 passes through the primer pump 374 and functions as an inlet channel 402 for the first media construction 348. In the embodiment illustrated in FIG. 38, a threaded receiver or socket 404 is also part of the housing 342, and is defined in particular by the lower housing 364. The socket 404 threadably receives a bolt 406 (FIGS. 47 and 50) extending in an interior 408 of the cover 344.

In the embodiment shown in FIG. 47, the cover 344 exposes bolt head 410. The bolt 406 includes threads 412, which mate with the threads in the socket 404 (FIG. 38). The combination of the bolt 406 with the rotatable knob 410 and the socket 404 in the housing 342 allows for selective securing or locking and selective unsecuring or unlocking of the cover 344 to the housing 342. Other securing arrangements are useable, such as latches or other fasteners.

In reference again to FIG. 31, another feature in the depicted embodiment of the cover 344 includes an air or gas port 414. The gas port 414 assists with draining the filter arrangement 340, during servicing, to allow for the flow of air into the housing 342.

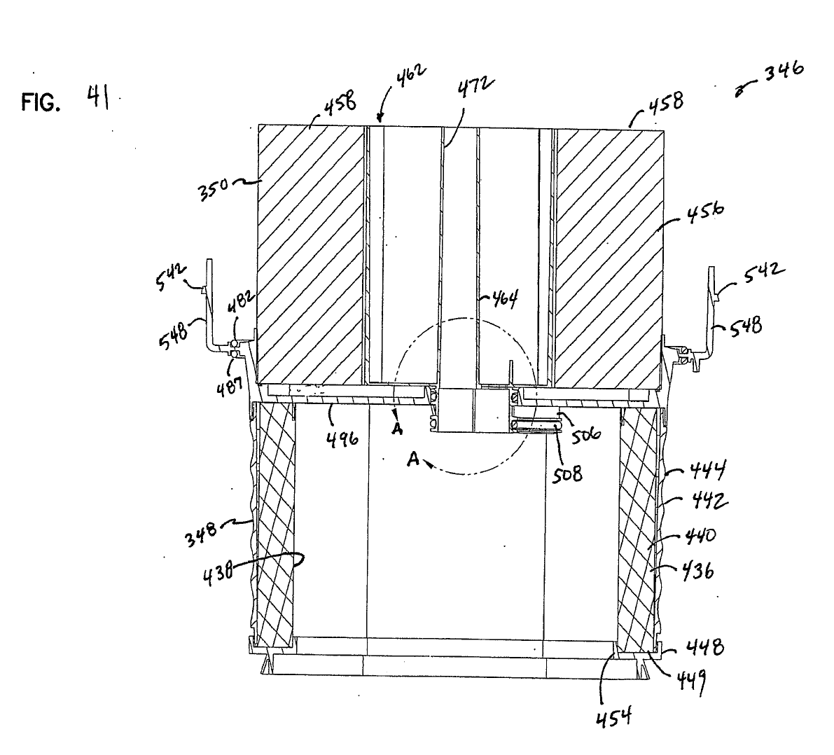

In reference now to FIGS. 31, 46, and 47, the cover 344 defines an outer flange 416. In use, the flange 416 will cooperate with a seal member 482 (FIG. 41) on the filter element 346 and form a seal 483 (FIG. 50) with the element 346.

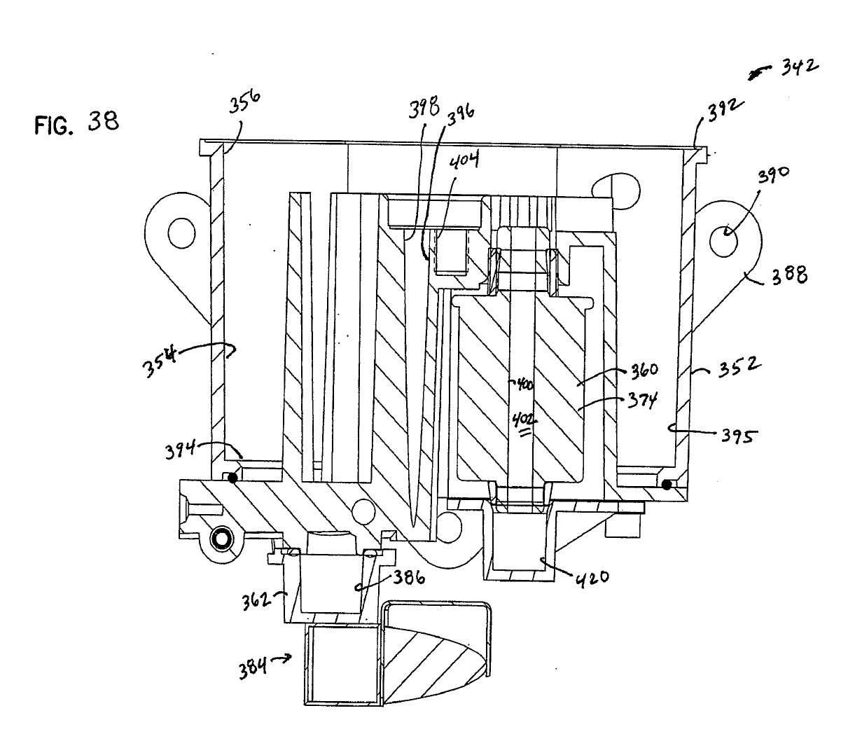

In FIG. 37 and FIG. 46, it can be appreciated that the housing 342 and the cover 344 are non-round in configuration. The cover 344, in the embodiment shown, is obround or generally oval. The access opening 356 in the housing 342 is generally the shape of the cover 344, and in the example shown, is generally oval or obround.

In reference again to FIGS. 31-38, the inlet and outlet arrangements in the housing 342 are now described. As mentioned above, an inlet arrangement 380 comprises a primary inlet port 420 (FIGS. 31, 32, 36, and 38). The primary inlet port 420 is in fluid flow communication with the primary filter inlet channel 402 (FIG. 38). The primary inlet port 420 is also in fluid flow communication with the fuel tank 32 (FIG. 2), such that fuel is drawn from the fuel tank 32, into the primary inlet port 420, and into the primary filter inlet channel 402. From there, the fuel travels to the first media construction 348, to be described further below.

A primary outlet port is defined by the housing at 422 (FIGS. 31 and 48). After the fuel passes through the first media construction 348, which will be situated in the seat 394 and in volume 395 (FIG. 38), the filtered fuel passes through the primary outlet port 422. In this embodiment, the fuel filtered by the first media construction 348 passes out of the housing 342 and to a transfer pump. In other embodiments, when the pump arrangement 360 (FIG. 36) operates as both a primer pump and transfer pump, then the filtered fuel will not need to exit the housing 342. FIGS. 50-53 show the first media construction 348 operably installed in housing 342.

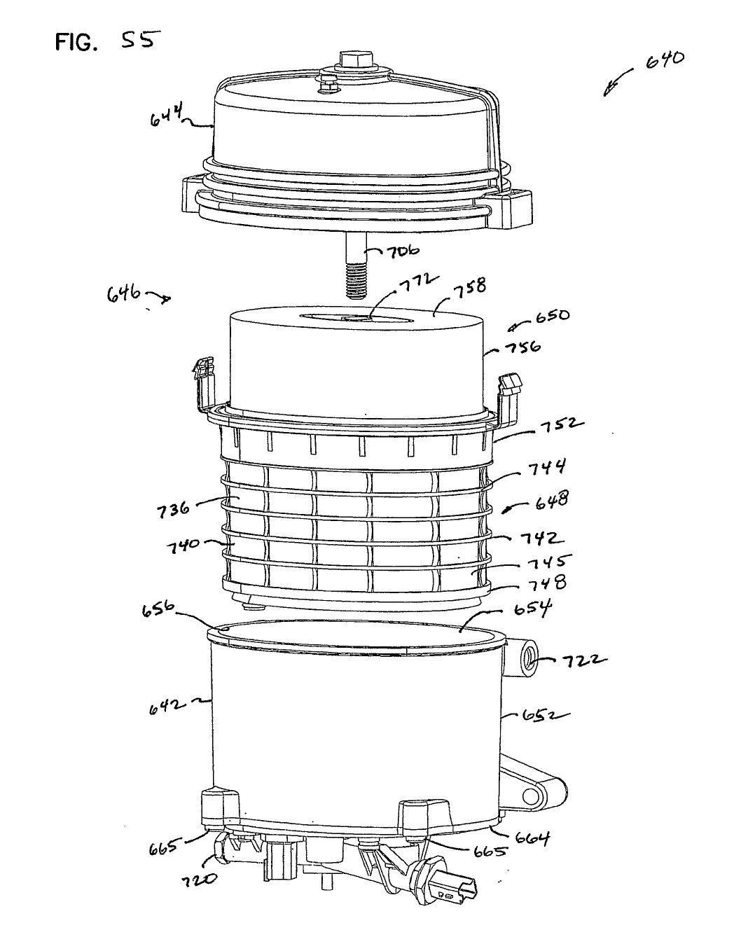

The housing 342 further includes a secondary inlet arrangement 424 (FIG. 54). In the embodiment shown, the secondary inlet arrangement 424 includes a secondary fluid inlet port 426. The secondary inlet port 426 is in fluid flow communication with the secondary inlet channel 398 (FIGS. 37, 38, 50, and 51). The fuel flows from the transfer pump through the secondary inlet port 426, into the secondary filter inlet channel 398 and to the secondary media construction 350, to be described further below.

The housing 342 further includes a secondary outlet arrangement 428 (FIG. 54). In the embodiment shown, the secondary outlet arrangement 428 includes a secondary outlet port 430 in fluid flow communication with a secondary outlet channel 432 (FIGS. 37 and 52). The fuel flows from the transfer pump, through the second inlet port 426, through the secondary filter channel 398, through the second media construction 350 (to be described further below), through the secondary outlet channel 432 (FIG. 52) and exits the housing through the secondary outlet port 430 (FIG. 54). From the secondary outlet port 430, the filtered fluid flows to the fuel injection system 36 (FIG. 2).

### F. Example Filter Element 346, FIGS. 31, 39-45, and 50-53

The example filter element 346, as mentioned above, includes the first media construction 348 and the second media construction 350. As can be seen in FIG. 31, the filter element 346 is operably installable, removable, and replaceable from the housing 342.

FIG. 39 depicts an exploded view of the example filter element 346. The filter element 346 depicted includes the first media construction 348 including a first filter media 436 having a tubular shape 437. By “tubular shape”, it is meant that the first filter media has a closed perimeter with an open, hollow interior 438. The tubular shape 437 can be generally cylindrical or non-cylindrical. In the embodiment shown, the tubular shape 437 of the first filter media 436 is non-round, and in particular, obround or oval. Many different types of filter media can be used for the first filter media 436, but in general, the media 436 is constructed for radial flow therethrough. One useable type of media for radial flow is pleated media 440. The pleated media 440 preferably will include a media with a hydrophobic coating to separate water from fuel that is passing through the first media construction 348. In other types of systems, other types of media will be used, as selected by the filter engineer.

The first media construction 348 further includes, in the embodiment shown, an outer liner 442 holding or supporting the first filter media 436. The outer liner 442 will help to prevent the pleats from collapsing, when pleated media 440 is used. The outer liner 442, in the embodiment shown, is generally a grid 444 that circumscribes the exterior 445 of the first filter media 436. In preferred embodiments, the exterior 445 will be the downstream side of the first filter media 436, as fluid to be filtered flows from the filter interior 438 through the first filter media 436.

The first media construction 348, in the embodiment shown, also includes a lower end cap 448. The lower end cap 448 secures to the end 449 of the pleated media 440. The opposite end 450 is secured to an end cap construction 452, which is axially between the first media construction 348 and the second media construction 350. The lower end cap 448 is an open end cap defining opening 454. The opening 454 allows the first media construction 348 to be positionable over and around to circumscribe internal components 358 of the lower housing 364. That is, the opening 454 allows the first media construction 348 to be fitted over and around the internal components 358, such that the internal components 358 are positioned within the open filter interior 438.

The second media construction 350 is axially aligned with the first media construction 348, as mentioned above. The second media construction includes second filter media 456. While a number of different filter media are useable, in the embodiment shown, the second filter media 456 is configured for axial flow, with the inlets and the outlets being at opposite axial ends of the second filter media 456. In the arrangement shown, the second filter media 456 has an inlet end at axial end 458, and an outlet end at opposite axial end 460.

In the embodiment shown, the second filter media 456 has non-pleated media configured for axial fluid flow. Such media can include Z-filter media as described in, for example, U.S. Pat. No. 6,783,565, incorporated herein by reference. Alternatively, the media 456 can include a plurality of layers of a filtration material stacked or wound in a spiral, wherein each layer is separated by a screen, and opposite alternating axial ends are blocked with a closure as described in U.S. provisional patent application 60/804,477 filed 12 Jun. 2006, commonly assigned and incorporated herein by reference. In the embodiment shown in FIG. 41, fluid to be cleaned, such as fuel on the downstream or pressurized side of the transfer pump, enters the housing through the secondary inlet port 426, travels through the secondary inlet channel 398 (FIGS. 37, 38, 50 and 51), and is conveyed to the inlet end 458 of the second media construction 350. The fuel to be cleaned then flows through the non-closed, open axial ends of the media 456. The fluid flows through the media 456 and exits the non-closed, open axial ends at the outlet end 460. From there, the cleaned fuel is conveyed through the secondary outlet channel 432 (FIGS. 37 and 52) and out through the secondary outlet port 430 (FIG. 54).

The first media construction 348 and second media construction 350 are fluidly isolated from each other. By the term “fluidly isolated”, it is meant that fluid that flows through the first media construction 348 and the second media construction 350 is separated by, at least, filtration media, while the primary inlet port 420 and primary outlet port 422 are completely separated from the secondary inlet port 426 and secondary outlet port 430.

In the embodiment shown in FIG. 39, the second filter media 456 has a non-cylindrical shape. Specifically, in the embodiment shown, the shape is oval, obround, or racetrack-shaped. In general, the outer perimeter of the second filter media 456 has the same shape of the outer perimeter of the first filter media 436, although the overall sizes may differ.

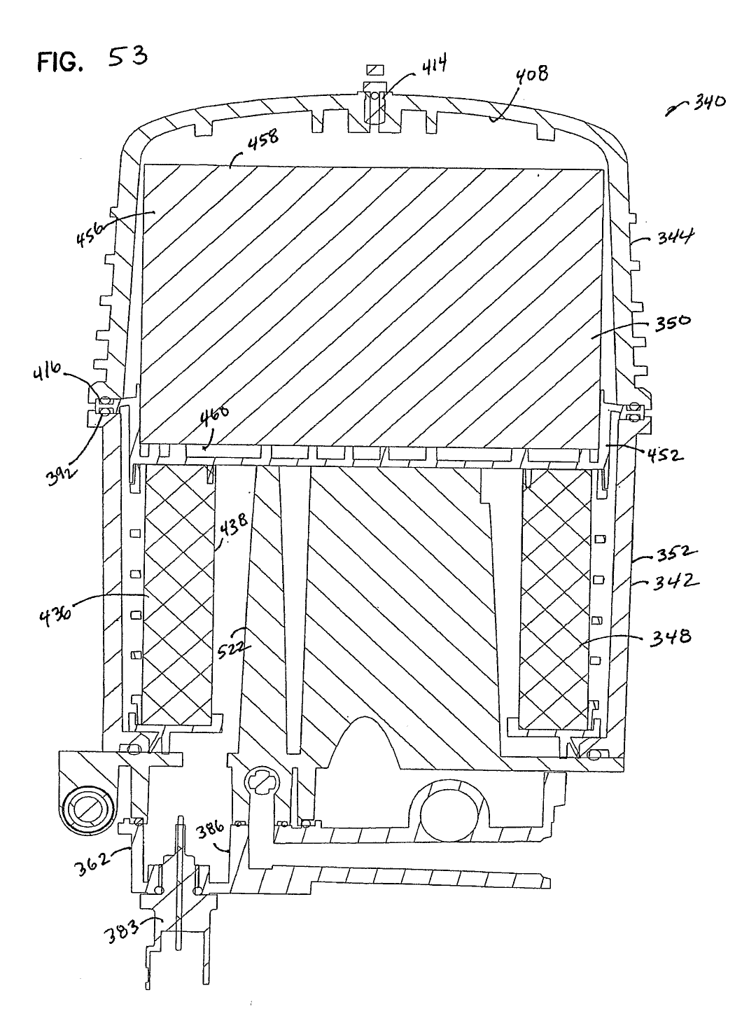

The filter element 346 further includes, in preferred embodiments, a center core construction 462 (FIGS. 41, 44, and 45). The center core construction 462, in the embodiment shown, is circumscribed by the second filter media 456. In preferred arrangements, the center core construction 462 includes at least one fluid-conveying tubular member 464. In preferred embodiments, the fluid to be filtered, such as fuel on the pressurized side of a pump, is conveyed through the secondary inlet channel 398 (FIGS. 37 and 38), through the fluid conveying tubular member 464, and then to the inlet end 458 of the second filter media 456. As can be seen in FIGS. 39, 41, 41A, 44, and 45, the fluid conveying tubular member 464 has a neck 466 at an end. The neck 466 defines grooves 467, 468 for holding seal members 469, 470 (FIG. 41A) for forming seals with adjoining parts. In the case of groove 468 and seal member 470, a seal 514 (FIGS. 50 and 51) is formed with the end cap construction 452, to be described further below. In the case of groove 467 and seal member 469, a seal 515 (FIGS. 50, 51) is formed with the secondary filter inlet channel 398 (FIGS. 37 and 38).

The fluid-conveying tubular member 464 forms a complete through hole or passage from end 473 to end 474 of the center core construction 462, in the embodiment shown (FIG. 45).

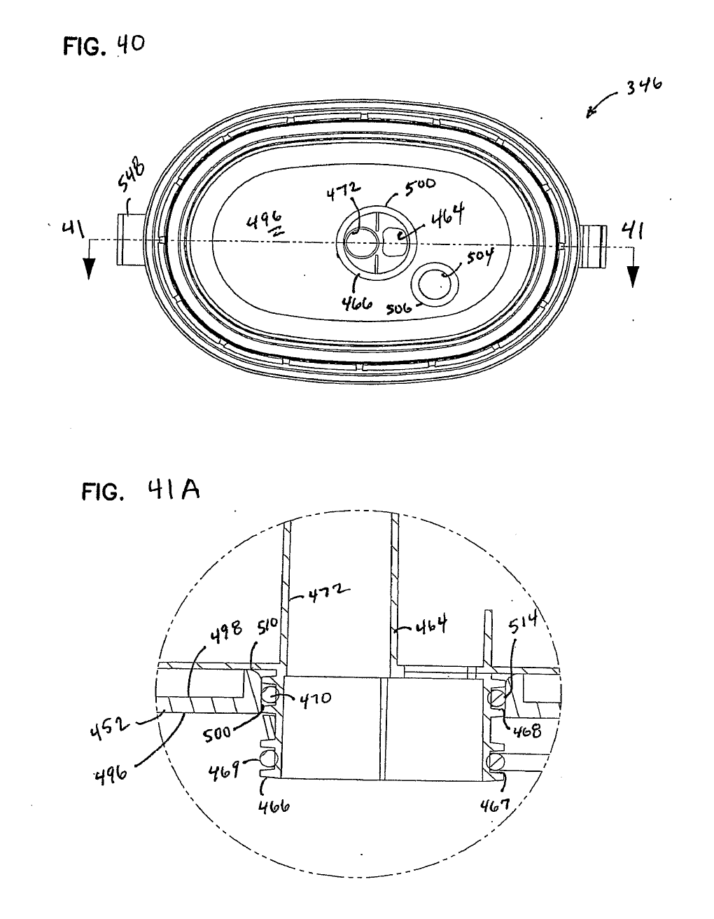

In FIG. 45, the center core construction 462 generally has an outer wall 463 and internal walls 465 to help form the fluid-conveying tubular member 464. In addition to the fluid-conveying tubular member 464, in preferred embodiments, the center core construction 462 defines a bolt-receiving tubular member 472 (FIGS. 40, 41, 44, 45 and 50). The bolt-receiving tubular member 472 defines a complete through hole from opposite axial ends 473 and 474. The bolt-receiving tubular member 472 operably receives a handle, and as embodied herein, the bolt 406 (FIGS. 47 and 50) projecting from the cover 344. As depicted in the embodiment of FIG. 50, the bolt 406 is allowed to pass through the second media construction 350 by passing through the bolt-receiving tubular member 472. The bolt 406 is then allowed to connect into the socket 404 of the housing 342.

The bolt-receiving tubular member 472 communicates with neck 466 at an end thereof. The neck 466 circumscribes and communicates with both tubular members 464 and 472.

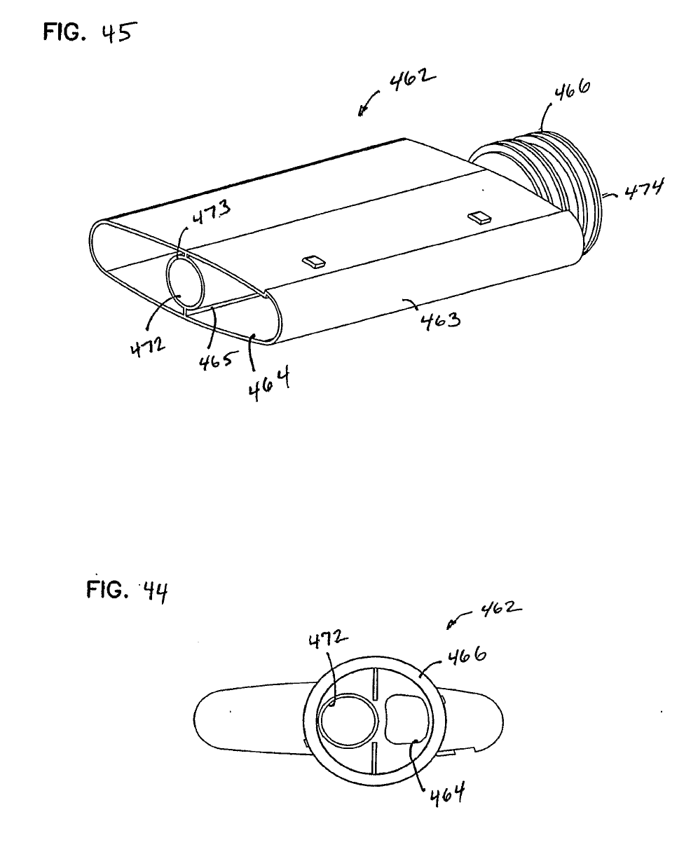

As can be seen in FIGS. 44 and 45, the center core construction 462 has a non-round perimeter, for example, an obround or racetrack-shaped perimeter. If other shapes for the second filter media 456 are desired, the shape of the center core construction 462 could be altered.

The filter element 346 further includes seal members 482, 487 circumscribing the first and second media constructions 348, 350. When the filter element 346 is operably installed within the housing 342, the seal members 482 and 487 form seals 483 and 489, respectively, between the filter element 346, the housing wall 352, and the cover 344. In the example embodiment shown, the seal member 482 forms a pinch seal 483 and the seal member 487 forms pinch seal 489 (FIGS. 50 and 51) by axial compression between the cover 344 and the housing 342. In example embodiments, the seal members 482, 487 can be made from rubber, compressible polyurethane foam, and other suitable materials. In preferred embodiments, the seal members 482, 487 are held and supported by the end cap construction 452.

The end cap construction 452 is now described in further detail. A preferred embodiment of the end cap construction 452 is shown in FIGS. 39-43. The end cap construction 452 depicted includes an outer band 484 holding the seal members 482, 487 on opposite sides 486, 488 of the band 484. In FIG. 41, it can be seen how in the particular embodiment illustrated, the seal members 482, 487, in cross-section, are circular, such as O-rings. When the filter element 346 is operably installed in the housing 342, the flange 416 of the cover 344 engages the first side 486, while the rim 392 of the housing 344 engages the second side 488. The rim 418 engages seal member 482. When the bolt head 410 is turned, it turns the bolt 406 which engages the threads 405 in the socket 404 and moves the cover 344 axially towards the housing 342. This results in a compressive force between the cover flange 416, the seal member 482, the seal member 487, and the rim 392 of the housing 342. The band 484 of the end cap construction 452 holds to support the seal members 482, 487 against these axial forces. This axial compression forms seals 483, 489 with the seal members 482, 487 between the cover 344 and the housing 342.

The end cap construction 452, in FIGS. 39 43, defines a pair of walls 492, 493, which function to hold the end 450 of the pleated media 440. The wall 492 is generally an outer wall and circumscribes the wall 493. These walls support the end 450 of the pleated media 440, and can hold adhesive, or potting compound, or other types of ways to fasten and secure the pleat ends of the media 440 to the end cap construction 452.

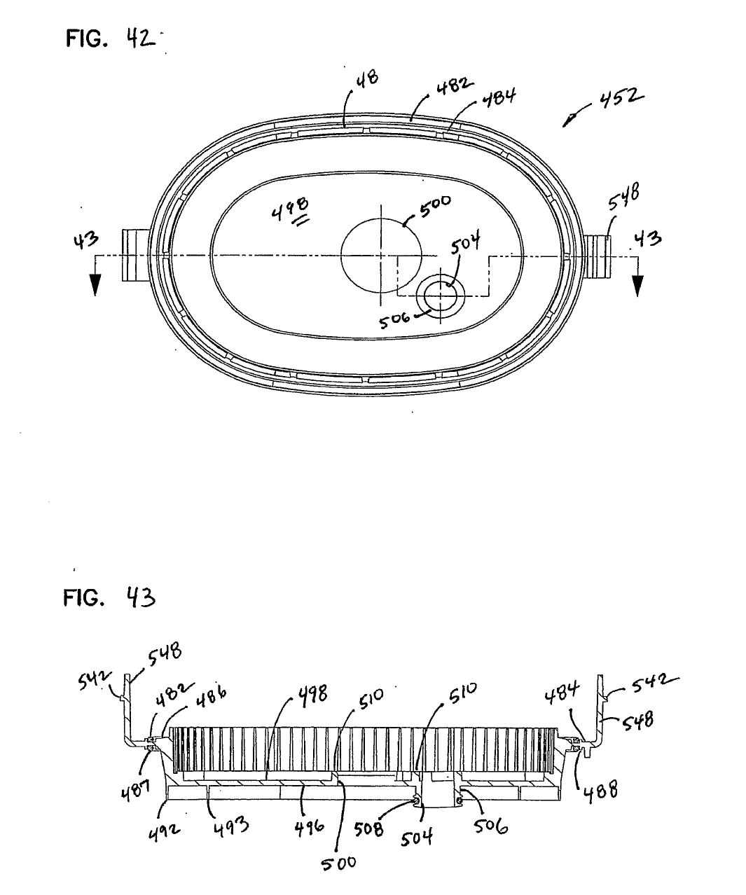

FIG. 40 shows a bottom plan view of the filter element 346. In FIG. 40, certain features of the end cap construction 452 are viewable. In particular, the end cap construction 452 has a generally planar first surface 496 and an opposite second surface 498 (FIG. 42). The end cap construction 452 defines at least one hole 500 accommodating the at least one fluid-conveying tubular member 464 of the center core construction 462. In particular, the hole 500 accommodates the neck 466 of the core construction 462 such that tubular members 464 and 472 are circumscribed by and communicate through the hole 500. As depicted in FIG. 41, the seal member 470 forms a radial seal 514 (FIGS. 41A, 51) between the end cap construction 452 and the neck 466 through the hole 500.

In preferred arrangements, the end cap construction 452 further includes at least one outlet hole 504 to convey fluid filtered by the second media construction 456. In the embodiment shown, the end cap construction 452 includes a tube 506 (FIGS. 41-43) extending from the planar first surface 496. The tube 506 defines the through hole 504 to convey fluid from the second surface 498 of the end cap 452 through the end cap 452. The tube 506 operably and removably connects to the second outlet channel 432 (FIGS. 37 and 52). In FIG. 43, it can be seen how the tube 506 holds a seal member 508 to form a releasable seal 520 (FIG. 52) between the tube 506 and the second outlet channel 432.

In reference now to FIG. 41, the end cap construction 452 further includes media standoffs 510. Media standoffs 510 support and hold the second filter media 456 over and above the second surface 498 of the end cap construction 452. This allows the filtered fluid to exit the downstream end 460 and be collected in the volume defined between the end 460 of the media 456 and the second surface 498. The filtered liquid that exits the downstream end 460 and is collected in this region, then flows through the hole 504, through the tube 506, to the second outlet channel 432, and out through the second outlet port 430. From there, it is used by the fuel injector system 36 (FIG. 2).

In preferred embodiments, the cover 344 is removably connected to the filter element 346. In particular, there is a latching mechanism 540 between the end cap construction 452 and the cover 344. The end cap construction 452 has a pair of projecting deflectable flanges 548, each having hooks 542 that engages a corresponding catch 544 on the cover 344. The cover 344 defines a pair of pockets 546 which forms the catches 544. The hooks 542 engage the respective catches 544 in the pocket 546. This engagement between the element 346 and cover 344 allows the element 346 to be removed with the cover 344 during servicing. Then, the element 346 can be removed from the cover 344 by deflecting the flange 548 to disengage the hooks 542 and catches 544.

In certain applications, it can be helpful to heat the fuel, particularly if it is diesel fuel. A variety of ways to heat the fuel can be implemented. In one implementation, warm fuel circulated through the cylinder head will enter at secondary fluid inlet port 426, such that it and secondary fluid inlet channel 398 are “hot in” ports. This fuel will in turn warm the lower housing casting 364. The fuel from the cold tank flows in through the same lower housing casting 364 at fluid channel 400 and surrounds the “hot in” ports 426, 398. This will warm the incoming fuel and operate similar to a shell and tube heat exchanger. In a second implementation, a wax valve can be installed into the housing at the lower housing casting 364 to circulate fuel from the cylinder rail into the primary filter 348. In another implementation, an electric heater is used adjacent to the inlet 420 to heat the fuel as it enters arrangement 340 from the cold fuel tank.

### G. Methods

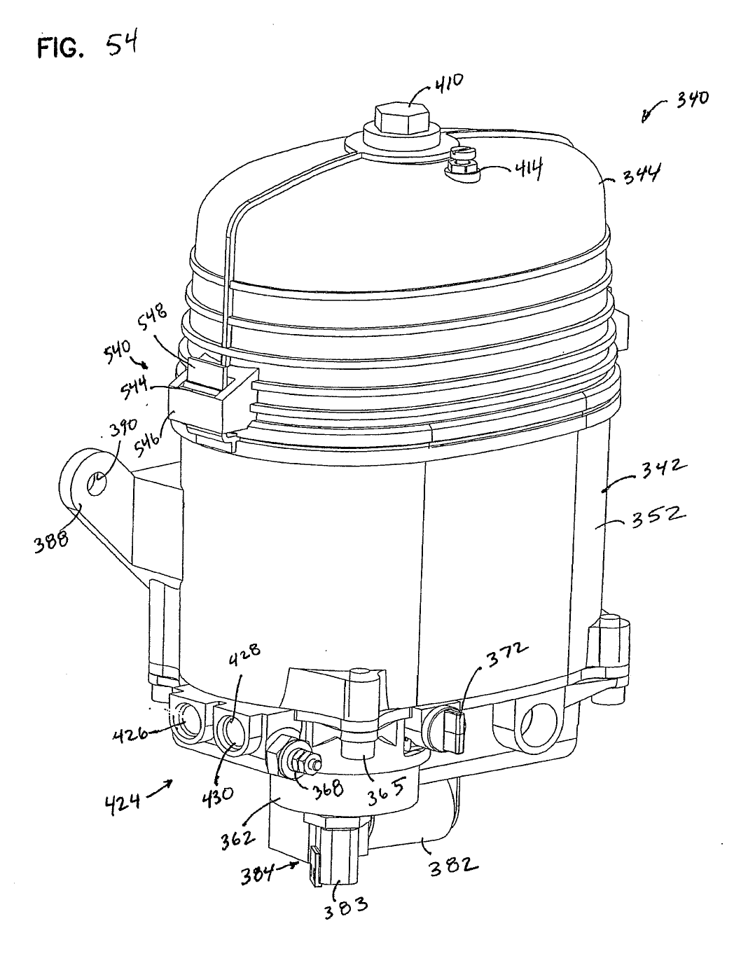

The filter arrangement 340 can be used to filter a variety of fluids. The fluids can be any type of system in which there is a filter upstream of a pump and a filter downstream of a pump. The example embodiment illustrated is for a fuel system. To filter fuel in a fuel system, the fuel is drawn from fuel tank 32 to primary filter 24 where water is separated and at least some particulate is removed. In the example shown, the fuel enters the filter arrangement 340 through the primary inlet port 420, where it is conveyed through the inlet channel 402. From there, it flows into the open filter interior 438 of the first filter media 436. Water is separated from the fuel by the filter media 436. The water drains downwardly through channel 522 (FIG. 53) and is collected in the bowl 362 in the water collection region 386. The water sensor 383 will detect when it is time to remove the water from the filter arrangement 340, and the water drain solenoid valve 382 will activate to remove the water from the filter arrangement 340.

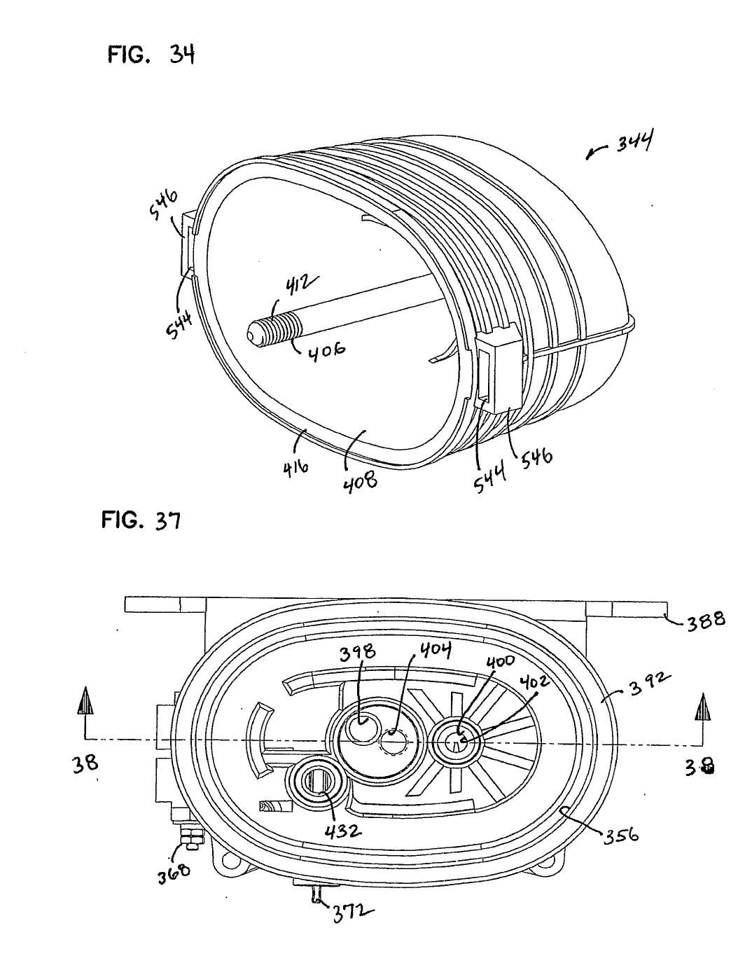

The fuel passes through the filter media 436 and then is drawn through the primary outlet port 422. From there, the fuel passes through the transfer pump and then is pushed through the secondary inlet port 426 (FIGS. 31, 36). The fuel passes from the secondary inlet port 426 through the secondary inlet channel 398 (FIGS. 37, 38, 50, 51), through the fluid conveying tubular member 464, and to the upstream side 458 of the second filter media 456. From there, the fuel flows axially through the media 456 and exits downwardly through the outlet end 460. The filtered fuel then collects in the region between the outlet end 460 and the second surface 498 of the end cap construction 452. The filtered fuel then flows through the hole 504 of the outlet tube 506 and then through the second outlet channel 432 (FIG. 52). From there, the fuel exits the housing 342 through the second outlet port 430 (FIGS. 33, 54). The filtered fuel then is used by the fuel injector system 36 (FIG. 2).

Periodically, the filter arrangement 340 will need servicing. To service the filter arrangement 340, the cover 344 is removed from the housing 342 and the filter element 346 is removed from the housing 342. The step of removing the filter element from the housing includes removing, simultaneously, the primary filter and the secondary filter, in the embodiment shown, the first media construction 348 and the second media construction 350. The step of removing the filter element 346 from the housing 342 can include removing the cover 344 and element 346 in a single step due to the latching member 540 connecting the element 346 to the cover 344.

The step of removing the cover 344 includes rotating the bolt head 410 to turn the bolt 406, which will back the cover 344 axially off of the housing 342. This releases the compression between the cover 344 and the housing 342, which releases the seals 483, 489 between the rim 416 of the cover 344, the seal members 482, 487, and the rim 392 of the housing 342. When the head 410 is turned, the bolt 406 is rotated, and extends through the second media construction 350 into the receiver or socket 404 in the housing 342. This will release the axial seals 483, 489 between the cover 344 and the housing 342.

When the filter element 346 is removed from the housing 342, the first media construction 348 is removed from around the pump arrangement 360 and from around internal components 358 including fluid channels 398, 402, and 432. The filter element 346 is then discarded and replaced with a new filter element 346. The filter element 346 is disengaged from the cover 344 and then discarded. The new filter element 346 is operably installed in the housing 342 by passing it through the opening 356 and orienting the open filter interior 438 around to circumscribe the pump arrangement 360 and internal components 358, including fluid channels 398, 402, and 432. The first media construction 348 is operably oriented within the filter seat 394. The seal members 482, 487 are seated against the rim 416, 392 of the cover 344 and housing 342, respectively.

During the step of operably orienting the filter element 346 in the housing 342, connections are made between the neck 466 and the secondary filter inlet channel 398 using seal member 469 to form seal 515. In addition, a connection is made between the tube 506 and the second outlet channel 432 with the seal member 508 to form seal 520.

The cover 344 is operably oriented over the filter element 346. The cover 344 is placed over the second media construction 350. The flange 416 of the cover 344 is seated against the seal member 482. The bolt head 410 is rotated to cause threaded engagement between threads 412 on the bolt 406 and threads 405 within the socket 404. This moves the cover axially against the housing 342 to cause compression of the seal member 482, 487 between the flange 416 and the rim 392 to form axial seals 483, 489.

The filter element 346 is connected to the cover 344 by engaging the hook 542 of the element 346 into the catch 544 of the cover 344, and then the assembly of the cover 344 and element 346 is operably installed within the housing 342.

The filter arrangement 340 should now be useable for filtering operation.

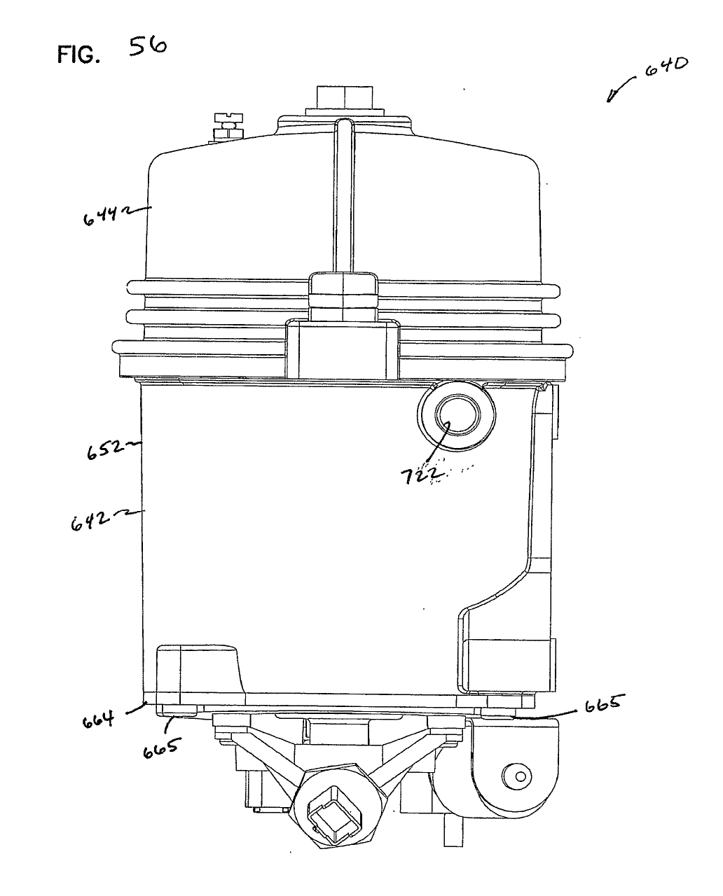

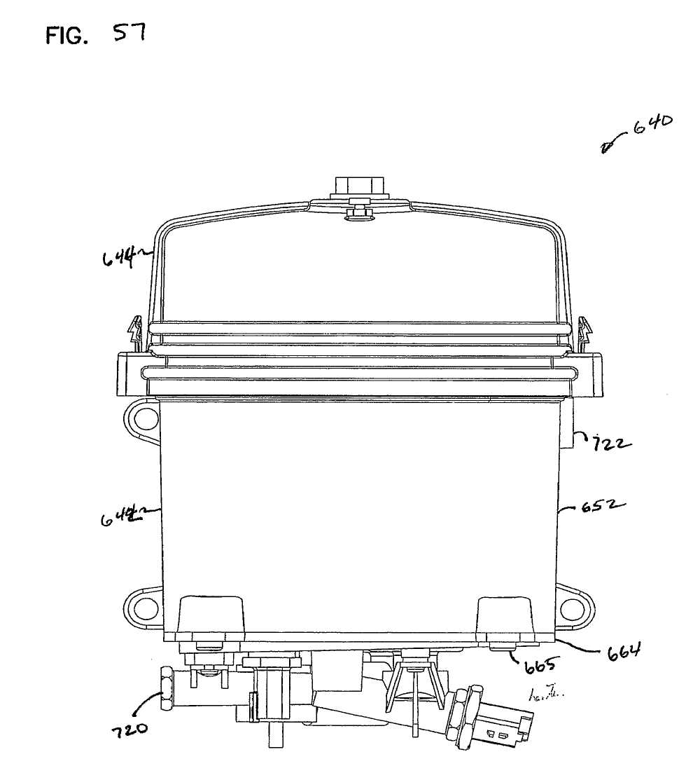

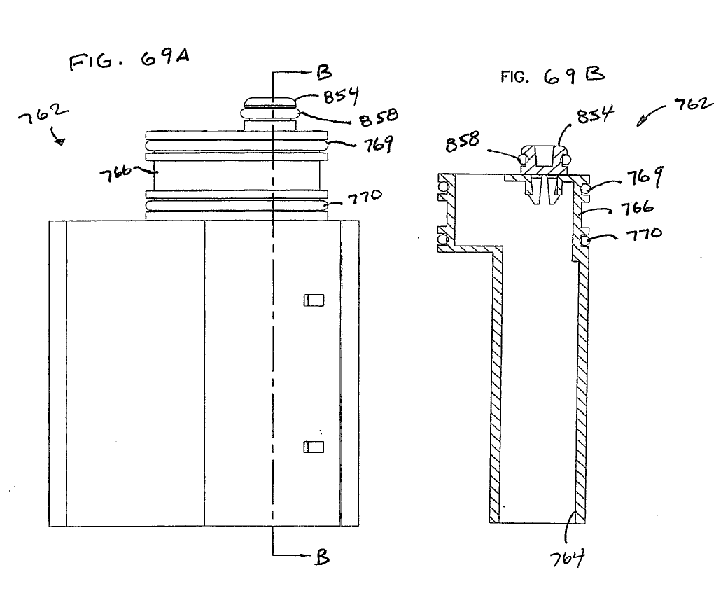

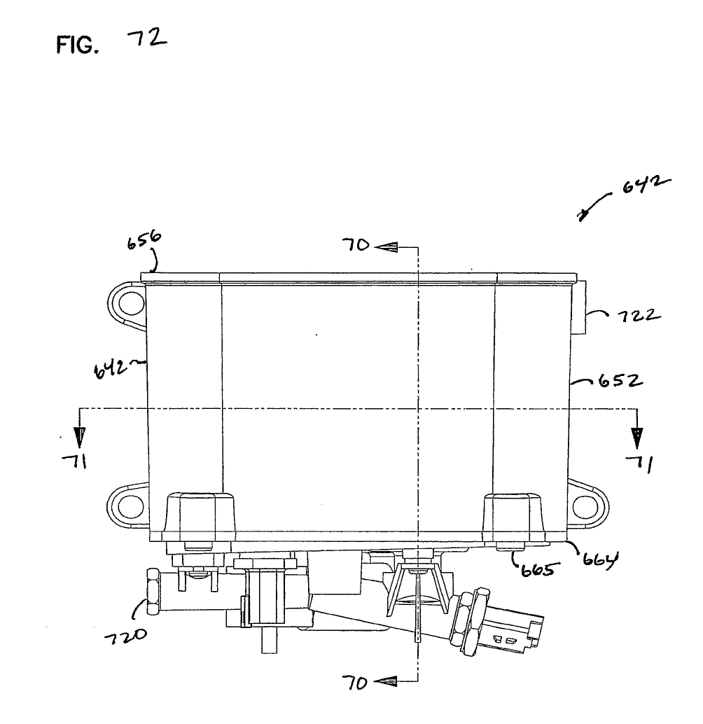

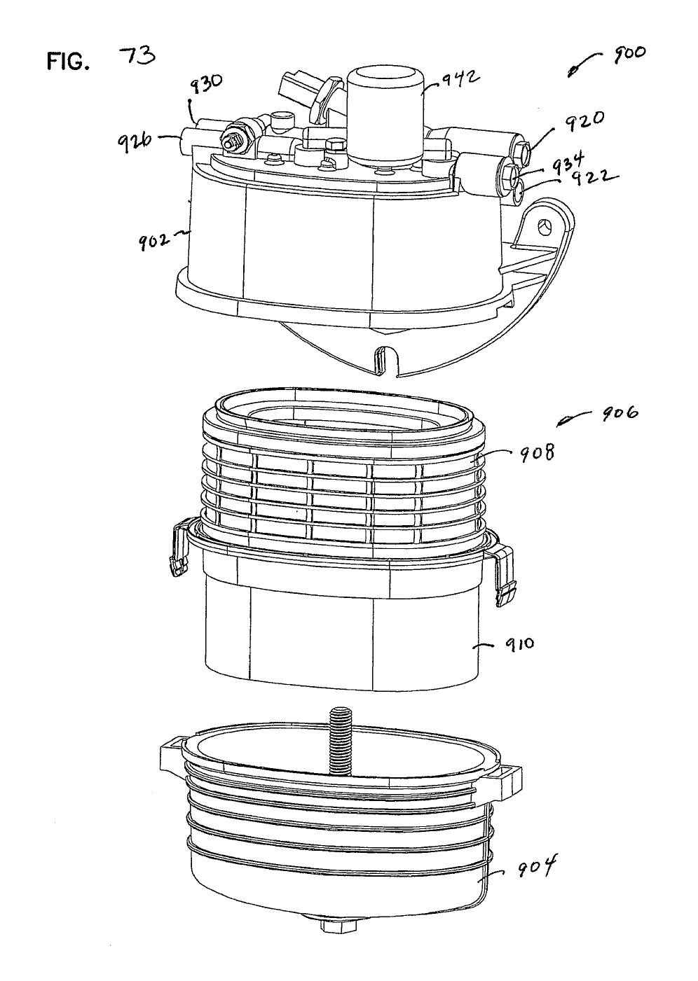

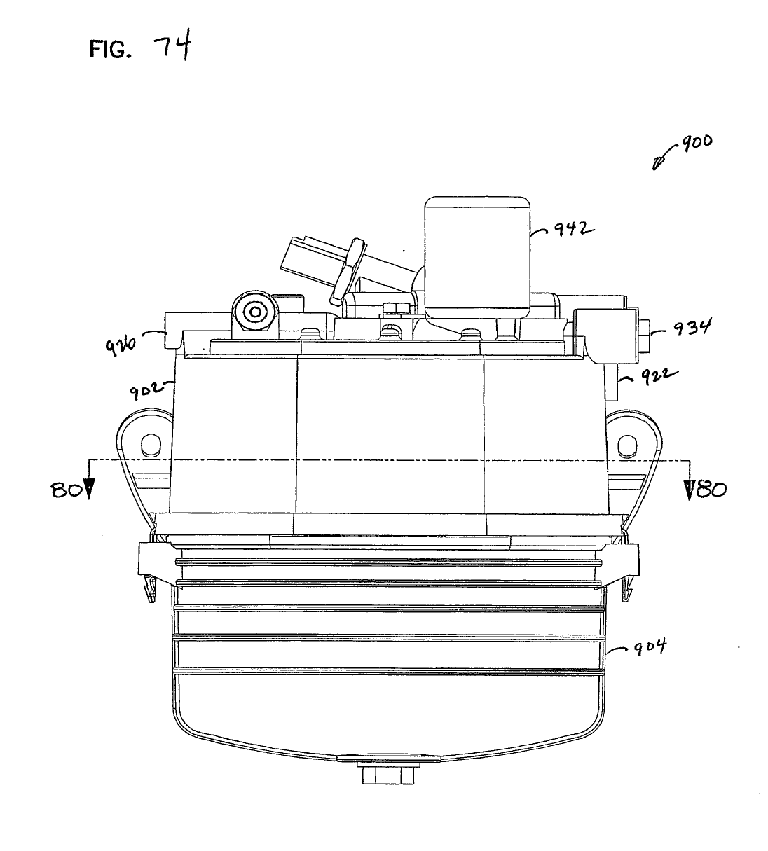

### H. Another Example Embodiment of a Filter Arrangement, FIGS. 55-72

FIG. 55 depicts an exploded perspective view of another embodiment of a filter arrangement 640. The filter arrangement 640 is usable in the fuel system 22 of FIG. 2, but it could also be used in other types of systems. In FIG. 55, a housing 642 with a removable cover 644 is shown containing a filter element 646. The filter element 646 is shown removed from the housing 642, and the cover 644 is shown removed from both the housing 642 and the filter element 646.

The filter arrangement 640 is similar to the filter arrangement 340 of FIGS. 31-54, but the filter arrangement 640 has additional features to allow for advantageous draining of the fluid (e.g., fuel) during servicing. Many of the components described with respect to FIGS. 31-54 are the same for the embodiment of FIGS. 55-72, and their descriptions are incorporated herein by reference. A summary of certain of those components are discussed below. A more thorough discussion of the features that relate to the draining system are discussed below.

As with the previous embodiments, the filter element 646 generally includes a first media construction 648 and a second media construction 650, in which the first and second media constructions 648, 650 are axially aligned (stacked one on top of another). In this embodiment, as with the previous embodiments, the second media construction 650 is shown stacked on top of the first media construction 648. Further, as with previous embodiments, the first media construction 648 and the second media construction 650 are fluidly isolated from each other.

The housing 642 includes an exterior wall 652 defining housing interior 654. The housing 642 has an access opening 656, which allows the filter element 646 to be inserted and removed. When the cover 644 is removed from the housing 642, the access opening 656 is exposed, exposing the filter element 646.

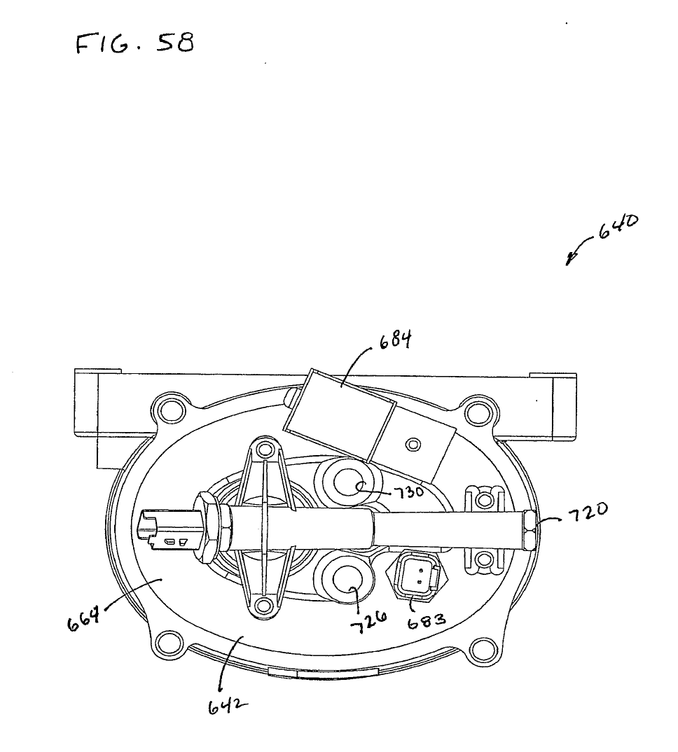

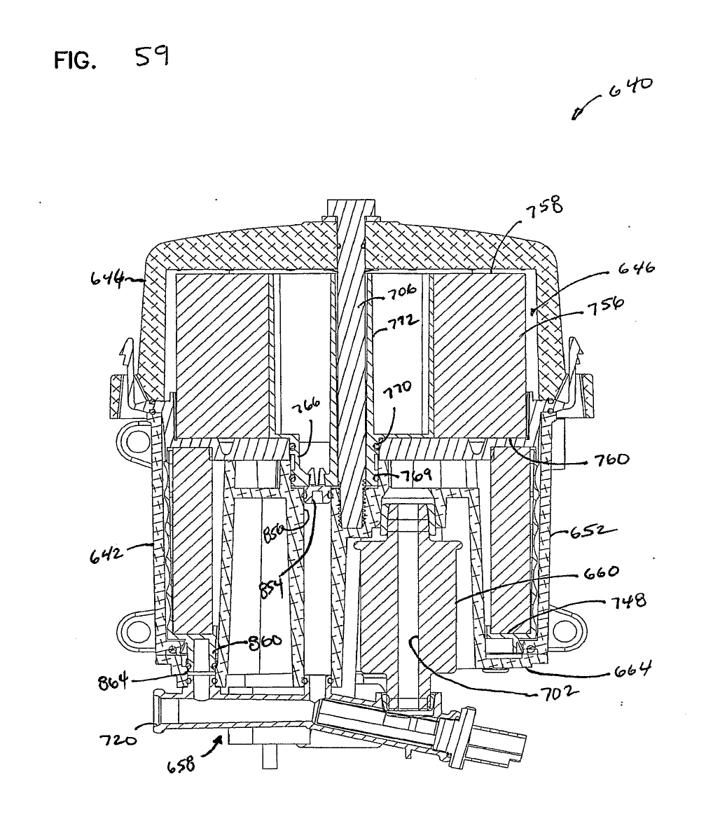

In FIG. 59, certain internal components 658 are depicted. Certain of the internal components 658, in the embodiment shown, include a pump arrangement 660, a lower housing 664, and water sensor and valve assembly 684 (FIG. 58).

The lower housing 684 is received within the exterior wall 652, and the wall 652 and lower housing 664 are secured together by fasteners, such as bolts 665. Also viewable in FIG. 58 is a water sensor at reference numeral 683. The pump arrangement at 660, can be a primer pump, a transfer pump, or a combination of both. In this example, the pump arrangement 660 operates as a primer pump 674.

The inlet and outlet arrangements in the housing 642 are now described. A primary inlet port is shown at 720 in FIGS. 55 and 57-59. The primary inlet port 720 is in fluid flow communication with the primary filter inlet channel 702 (FIG. 59). The primary inlet port 720 is also in fluid flow communication with the fuel tank 32 (FIG. 2), such that fuel is drawn from the fuel tank 32 into the primary inlet port 720, and into the primary filter inlet channel 702. From there the fuel travels to the first media construction 648, to be described further below.

A primary outlet port is defined by the housing at 722 (FIGS. 55-57 and 72). After the fuel passes through the first media construction 648, the filtered fuel passes through the primary outlet port 722. In this embodiment, the fuel filtered by the first media construction 648 passes out of the housing 642 and to a transfer pump. In other embodiments, when the pump arrangement 660 operates as both a primer pump and transfer pump, then the filtered fuel will not need to exit the housing 642.

The housing 642 further includes a secondary inlet port 726 (FIG. 58), which is in fluid flow communication with a secondary inlet channel 698 (FIG. 71). The fuel flows from the transfer pump through the secondary inlet port 726, into the secondary filter inlet channel 698, and to the secondary media construction 650, to be described further below.

The housing 642 further includes a secondary outlet port 730 (FIG. 58). The fuel flows from the transfer pump, through the secondary inlet port 626, through the secondary inlet channel 698 (FIG. 71), through the second media construction 650, through an outlet channel 732 (FIG. 71), and exits the housing through the secondary outlet port 730. From the secondary outlet port 730, the filtered fluid flows to the fuel injection system 36 (FIG. 2).

Filter element depicted in FIGS. 55 and 59-61 is analogous to the filter element 346 described above, with the only exception being two features that related to the drain construction, described below. The features that relate to the drain construction are built into the center core construction 762, described further below.

As described above for filter element 346, the filter element 646 is non-round, and in particular, obround or oval. The media 736 for the first media construction 648 can be a variety of types, but in the example shown, is constructed for radial flow and uses pleated media 740. The first media construction 648 includes an outer liner 742 embodied as a grid 744 circumscribing the exterior 745, which will generally be the downstream side of the first filter media 736. The first filter media construction 648 also includes a lower endcap 748 secured thereto and at an opposite end, endcap construction 752. The endcap construction 752 is axially between the first media construction 648 and the second media construction 650.

The second media construction 650 includes second filter media 756. Again, a variety of filter media are usable, and in the preferred embodiment, the second filter media 756 is configured for axial flow with inlets and outlets being at opposite axial ends. In the arrangement shown, the second filter media 756 has an inlet end at axial end 758 and an outlet end at opposite end 760. The second filter media 756 will preferably be the type as described above in connection with media 456, which description is incorporated herein by reference.

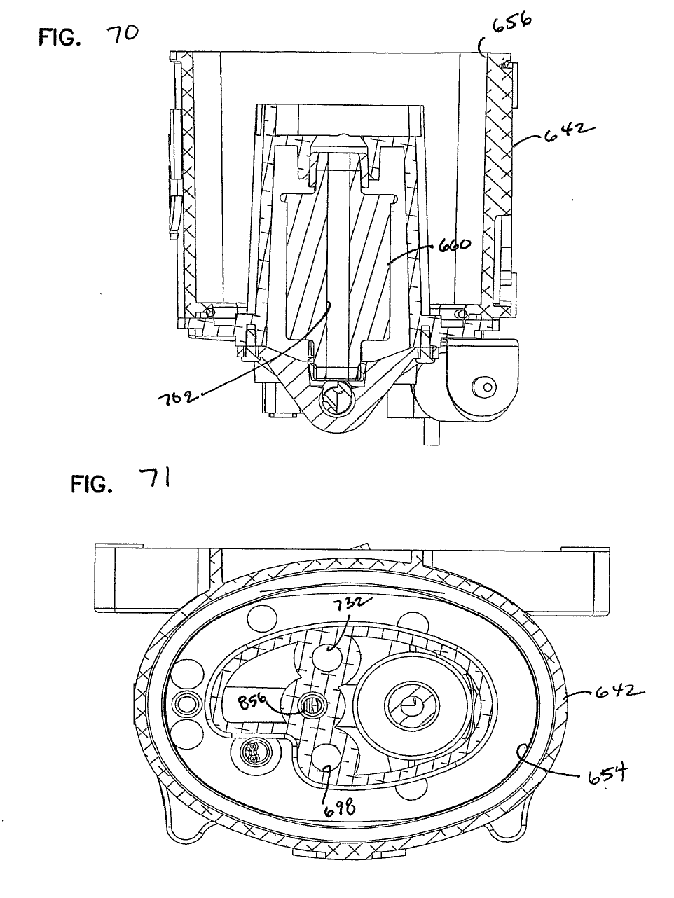

As with the previous embodiments, in this embodiment, the first media construction 648 and the second media construction 650 are fluidly isolated from each other. The filter element 646 includes center core construction 762 (FIGS. 68 and 69). In the embodiment shown, the center core construction 762 includes an inlet fluid-conveying tubular member 764. In preferred embodiments, the fluid to be filtered, such as fuel on the pressurized side of a pump, is conveyed through the secondary inlet channel 698 (FIG. 71) through the fluid-conveying tubular member 764 and then to the inlet end 758 of the second filter media 650. The fluid-conveying tubular member 764 has a neck 766 that holds seal members 769, 770 for forming seals with adjoining parts. The fluid-conveying tubular member 764 forms a complete passage from end 773 to end 774 of the center core construction 762.

The center core construction 762 has an outer wall 763 and internal walls 765 to help form the fluid-conveying tubular member 764. As with the previous embodiment, in addition to the fluid-conveying tubular member 764, in preferred embodiments, the center core construction 762 includes a bolt-receiving tubular member 772. The bolt-receiving tubular member 772 defines a complete through-hole from opposite axial ends 773, 774. The bolt-receiving tubular member 772 operably receives a bolt 706 projecting from the cover 644. The bolt 706 is allowed to pass through the second media construction 650 by passing through the bolt-receiving tubular member 772. The bolt 706 is then allowed to connect into a socket 704 (FIG. 59). The neck 766 circumscribes both the bolt-receiving tubular member 772 and the fluid-conveying member 764.

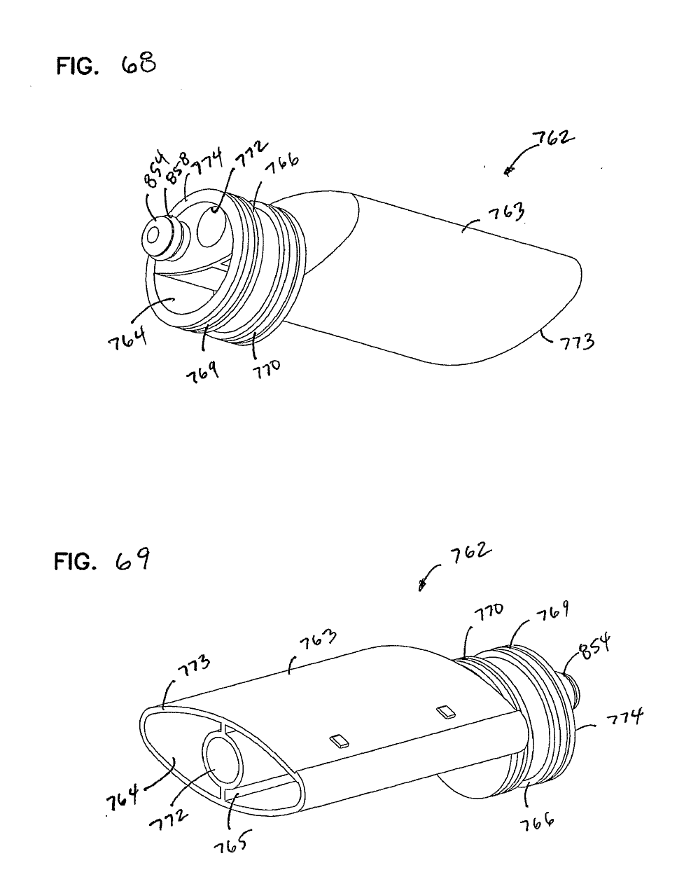

In this embodiment, the center core construction 762 further includes provisions for draining of the filter arrangement 640 during servicing. In FIGS. 66-69, the center core construction 762 is shown as having a plug member 854. The plug member 854 projects from an axial portion of the projecting neck 766. The plug member 854 is received by and operably fits into a secondary drain member port 856 (FIGS. 59 and 71). The plug member 854 has an O-ring seal member 858 that forms a seal with the secondary drain member port 856.

The filter element 646 includes seal members 782, 787 circumscribing the first and second media constructions 648, 650, in the same way as seal members 482, 487 circumscribe the first and second media constructions 348, 350 in the previously described embodiment. The seal members 782, 787 seal in the same manner as the previous embodiment of filter arrangement 340. The seal members 782, 787 are held and supported by the end cap construction 752.

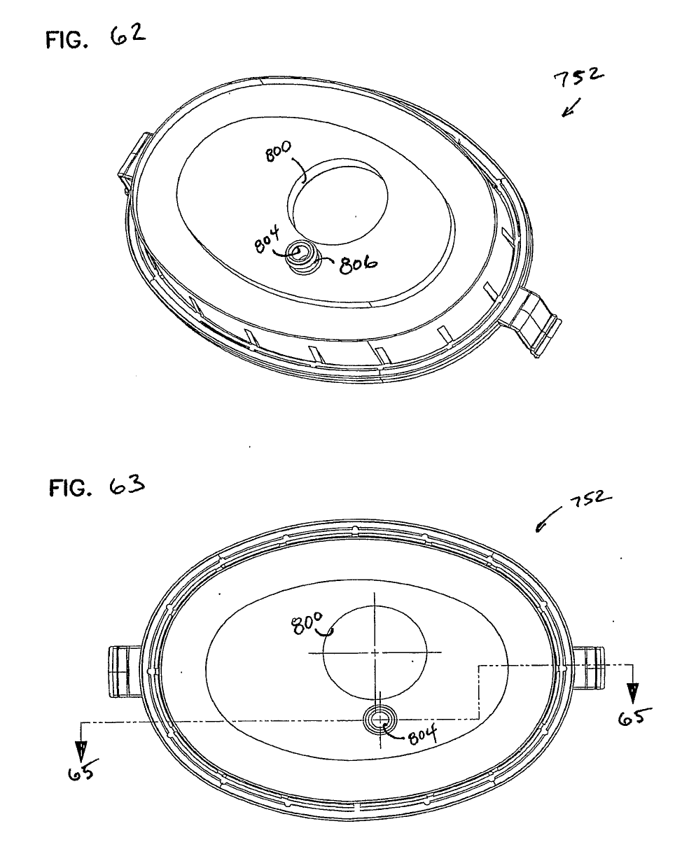

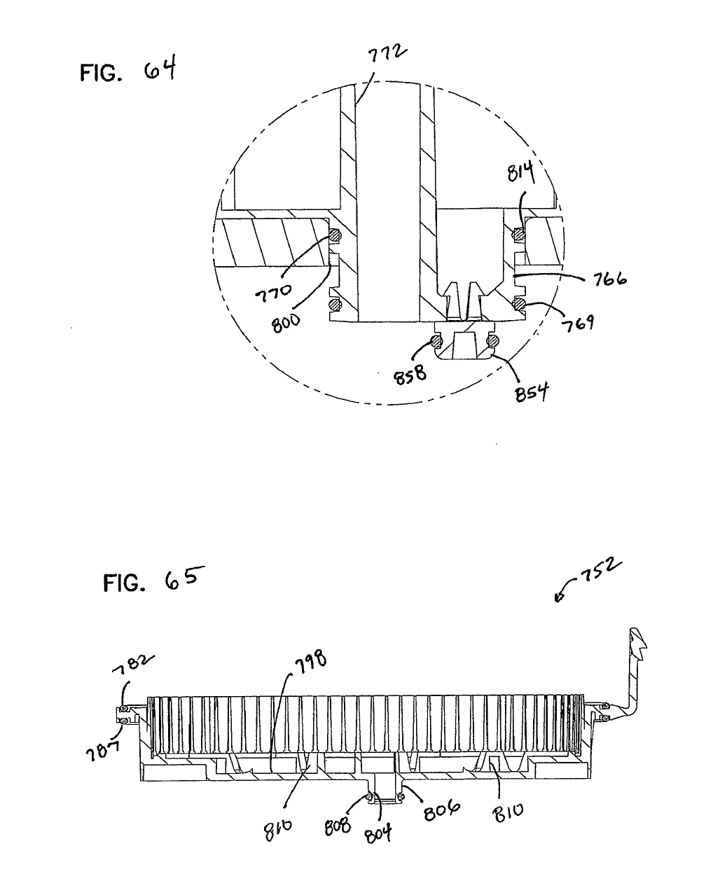

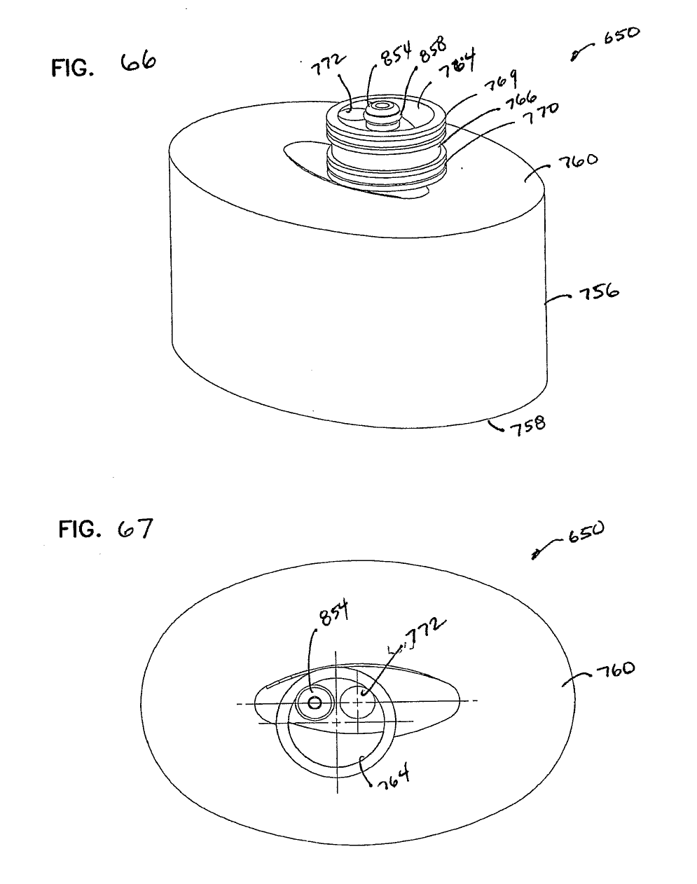

The endcap construction 752 is analogous to the endcap construction 452 and generally includes the same features. A description of those features with respect to endcap construction 452 is incorporated herein by reference with respect to endcap construction 752. The endcap construction 752 includes a hole 800 (FIGS. 62, 65) accommodating the neck 766 of the center core construction 762. In FIG. 64, it can be seen how the seal member 770 forms a radial seal 814 between the endcap construction 752 and the neck 766 through the hole 800.

The endcap construction 752 includes an outlet hole 804 to convey fluid filtered by the second media construction 756. The endcap construction 756 includes tube 806 that defines hole 804 to convey fluid from the second surface 798 of the endcap construction 752 through the endcap construction 752. The tube 806 operably and removably connects to secondary outlet channel 732 (FIG. 71). The tube 806 holds a seal member 808 to form a releasable seal, which is analogous to the releasable seal 520 (FIG. 52) with the secondary outlet channel 732, in this embodiment.

The endcap construction 752 further includes media stand-offs 810 (FIG. 65). Media stand-offs 810 support and hold the second filter media 756 over and above the second surface 798 of the endcap construction 756. This allows the filtered fluid to exit the downstream end 760 and be collected in the volume defined between the end 760 and the second surface 798. The filtered liquid then flows through the hole 804, through the tube 806, to the secondary outlet channel 732 and out through the secondary outlet port 730. From there, it is used by the fuel injector system 36 (FIG. 2).

The cover 644 is analogous to the cover 344 and latches in the same way as the latching mechanism 540 described above. The description of the latching mechanism 540 is incorporated herein by reference with respect to the latching mechanism for this embodiment.

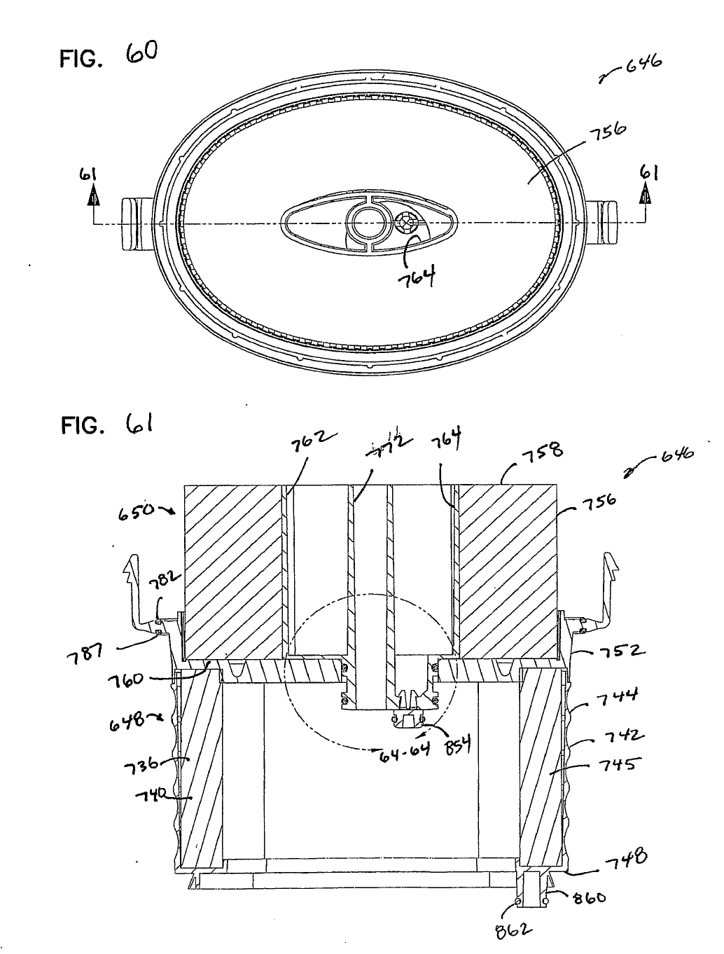

Attention is directed to FIGS. 59 and 61. A primary plug member 860 is axially projecting from the lower endcap 748 of the first media construction 648. The primary plug member 860 is part of the features related to the drain construction that are different from the previously-described embodiments. The primary plug member 860 includes an O-ring seal member 862 and is received by a primary drain port 864 (FIG. 59).

In operation, the normal filtration of the filter arrangement 640 is analogous to the filtration of the filter arrangement 340. As such, the fuel is drawn from fuel tank 32 (FIG. 2) through the primary inlet port 720, where it is conveyed through inlet channel 702. From there, it flows into the open filter interior 738 of the first filter media 736. Water is separated from the fuel by the filter media 736. The water drains downwardly in analogous ways as the previous embodiment, in which water sensor 683 will detect when it is time to remove the water from the filter arrangement 640, and the solenoid valve assembly 684 will activate to remove the water from the filter arrangement 640. The fuel passes through the filter media 736 and is drawn through the primary outlet port 722. From there the fuel passes through the transfer pump and then is pushed through the secondary inlet port 726. The fuel passes from the secondary inlet port 726 through the secondary inlet channel 698 (FIG. 71), through the fluid-conveying tubular member 764 and to the upstream side 758 of the second filter media 756. From there, the fuel flows axially through the media 756 and exits downwardly through the outlet end 760. The filtered fuel then collects in a region between the outlet end 760 and the second surface 798 of the endcap construction 752. The filtered fuel then flows through the hole 804 of the outlet tube 806 and then through the secondary outlet channel 732 (FIG. 71). From there, the fuel exits the housing 642 through the outlet port 730. The filtered fuel then is used by the fuel injector system 36 (FIG. 2).

Periodically, the filter arrangement 640 will need servicing. To service the filter arrangement 640, the cover 644 is removed from the housing 642, and the filter element 646 is removed from the housing 642. The step of removing the cover 644 from the housing 642 is analogous to the step of removing the cover 344 from the housing 342 described above. In this embodiment, as mentioned above, there are features for advantageous draining during servicing. When the filter element 646 is removed from the housing 642, the drain ports 856, 864 will be released before other ports. This is to allow fuel to escape back into the tank 32 before the second filter media 756 in the cover 644 releases its fuel. This is done to prevent a large volume of fuel entering the housing 642 from the cover area 644 and over-flowing the assembly. The seals created by the O-ring seal member 858 and O-ring seal member 862 are released before certain other seals in the system are released. For example, the radial seal 814 (FIG. 64) as well as the seal created by seal member 782 between the endcap construction 752 and the covers 644 remain intact while the seal between the seal member 858 on the plug member 854 and the secondary drain member port 856 is released along with the seal between the seal member 862 and primary drain port 864. As the cover 644 continues to be removed from the housing 644, the remaining seals in the system are released, and any remaining fuel in the cover 644 is released and is captured in the housing 642. The cover 644 and the filter element 646 can then be removed to the disposal location. Any fuel remaining in the housing 642 will continue to drain.

The remaining steps of servicing are analogous to the steps described above with respect to the filter arrangement 340, and that description is incorporated herein by reference.

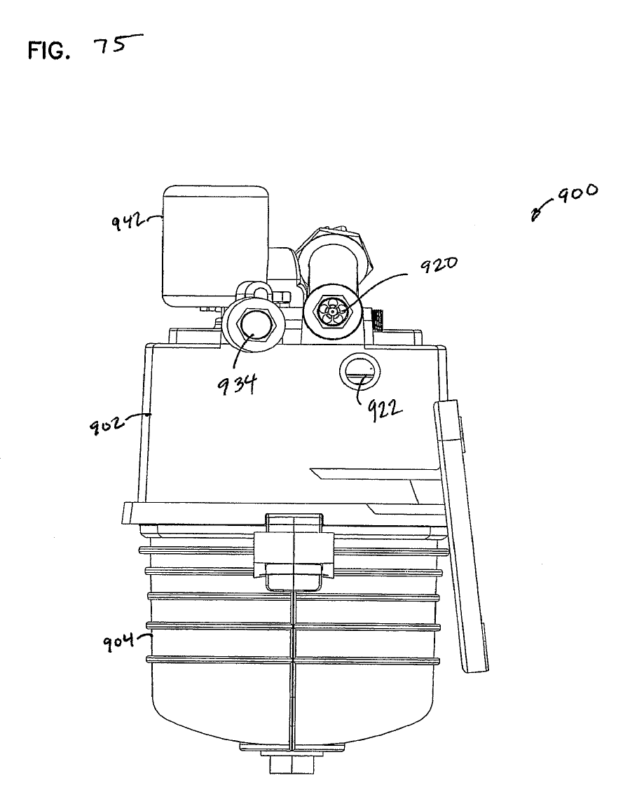

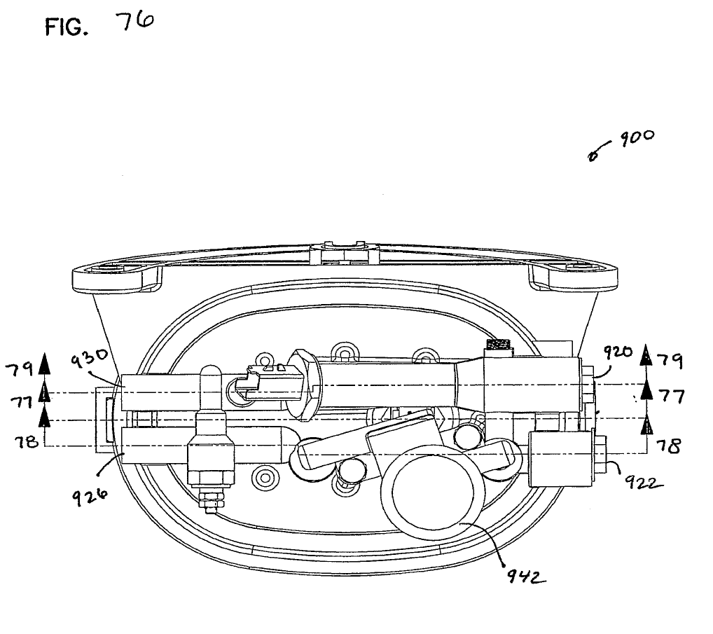

### I. Bottom-Load Embodiment, FIGS. 73-80

FIGS. 73-80 depict another embodiment of a filter arrangement at 900. In this embodiment, the filter arrangement 900 is a bottom-load embodiment. Previous embodiments described are top-load arrangements. In top-load arrangements, the filter arrangements are serviced by accessing them from the top, often, by raising the hood of the vehicle and accessing it from over the engine. In a bottom-load arrangement, the filter arrangement is accessed from under or below the engine. The filter arrangement 900 depicted in FIGS. 73-80 is very similar to the filter arrangement 340 of FIGS. 31-54, except that it is upside down, though there are certain other changes in the flow path.

FIG. 73 is an exploded perspective view of the filter arrangement 900. In FIG. 73, filter housing 902, cover 904, and filter element 906 are visible. The cover 904 and the filter element 906 are the same as previously-described cover 344 and filter element 346. As can be seen in FIG. 73, however, the filter arrangement 900 is upside down from the arrangement shown in FIG. 31. While in FIG. 31 the primary filter media construction 436 was below the secondary filter media construction 456, in this embodiment, it is the opposite. That is, the primary filter media construction 908 is above the second filter media construction 910.

Still in reference to FIG. 73, the filter housing 902 includes a primary inlet port 920, a primary outlet port 922, a secondary inlet port 926, a secondary outlet port 930, and a water purge/drain port 934. Fuel to be filtered from the fuel tank 32 (FIG. 2) enters the filter arrangement 900 through the primary inlet port 920, flows through the primary filter media construction 908, and then exits the housing 902 through the primary outlet port 922. The primary filter element construction 908 operates in the same way as described above in previous embodiments. The primary filter media construction 908 removes particulate and water from the fuel. Water is removed from the fuel and is directed to the drain port 934. The filtered fuel is directed through the primary outlet port 922. From there the fuel passes through a transfer pump and then is pushed through the secondary inlet port 926. The fuel passes from the secondary inlet port 926, through the secondary filter media construction 910 and then through the secondary outlet port 930. From there, the filtered fuel is used by the fuel injector system 36 (FIG. 2).

FIGS. 74-76 show exterior views of the assembled filter arrangement 900. It can be seen how the cover 904 secures to the housing 902 in an analogous manner as previous embodiments.

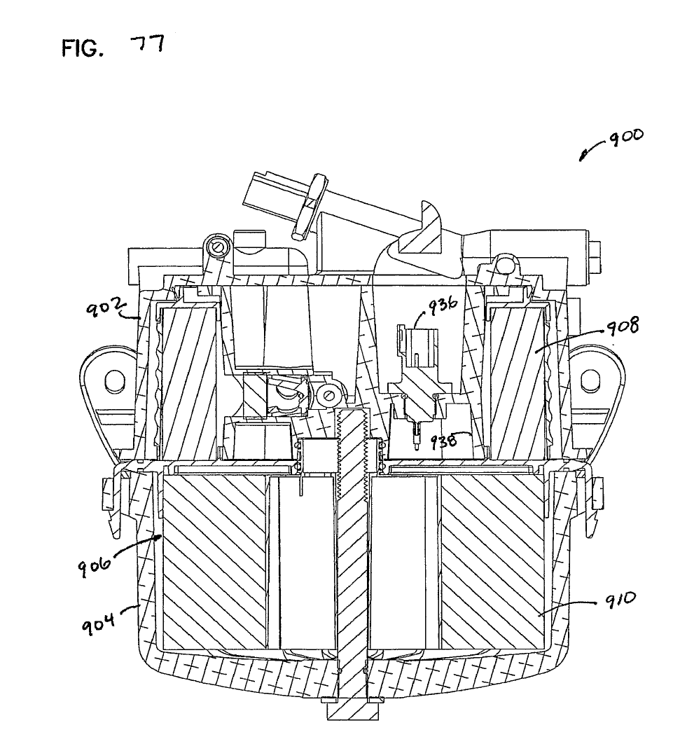

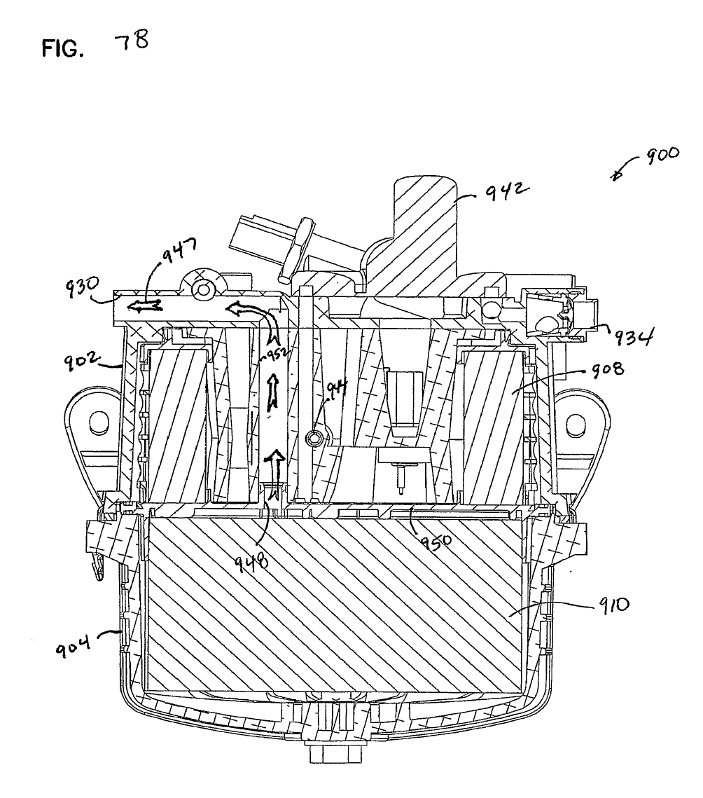

In FIG. 77, a water sensor 936 is viewable. The water sensor 936 senses or detects the level of water collected within water collection chamber 938. As water is separated from fuel by the primary filter media construction 908, the water collects within the water collection chamber 938. The sensor 936 is disposed in a location to sense and detect the level of water.

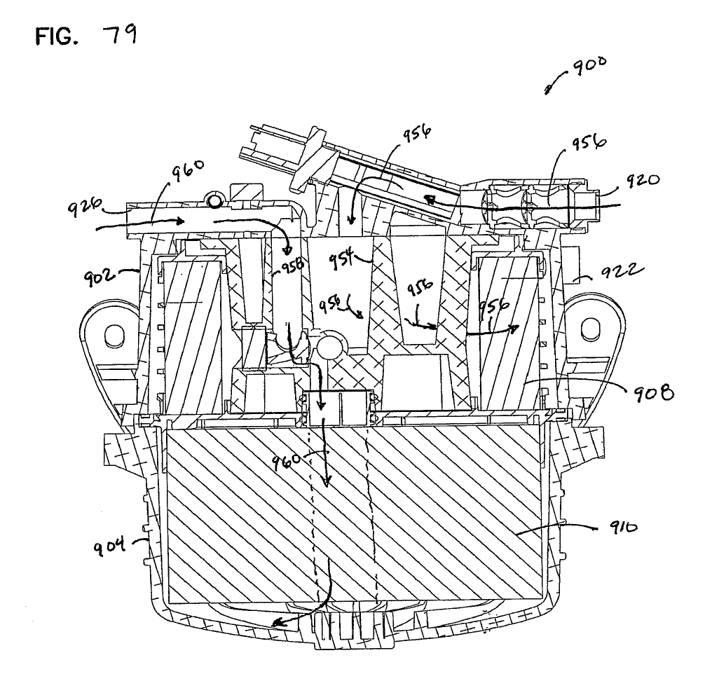

In FIG. 78, a pump 942 is visible. Also viewable in FIG. 78 is a pressure-activated check valve 944. The fuel, as it is exiting the secondary filter media construction 910 can be seen at arrows 947 flowing from the second filter media construction 910, through a hole 948 in endcap construction 950 and through a secondary outlet channel 952, through the outlet port 930. The check valve 944 operates at a pressure of about 15-20 psi.

In FIG. 79, the flow of the fuel through the primary filter media construction 908 can be seen. The fuel enters the arrangement 900 through the port 920 and into the primary fuel inlet channel 954. Arrows 956 show the path of the fuel as it is filtered through the primary filter media construction 908. The path of the fuel as it enters the secondary filter media construction 910 is also viewable in FIG. 79. This fuel enters a secondary inlet path 958 and is shown at arrows 960. When the fuel reaches the second filter media construction 910, it passes through a center tube within the center core construction, described above at FIGS. 45 and 46, for example. The fuel then flows axially through the second filter media construction 910 and exits through the hole 948 (FIG. 78), where it flows through the channel 952 and out through the secondary outlet port 930.

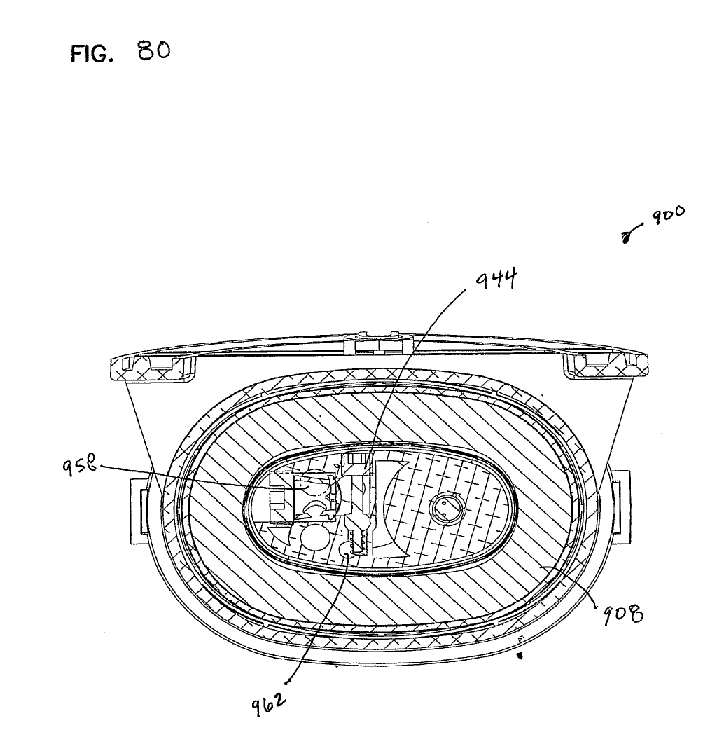

In FIG. 80, the pressure-activated check valve 944 is viewable. In addition, the secondary inlet path 958 is viewable, as is a channel 962 which leads to the water-purge/drain port 934.

To service the filter arrangement 900, the arrangement 900 is accessed from below, and the cover 904 is removed. This can also remove the filter element 906, which in preferred embodiments, is removably attached to the cover by the latching connection therebetween (as shown in reference number 540, FIGS. 50 and 54, for example). The old filter element 906 is then discarded, and a new replacement filter element 906 is provided and removably attached to the cover 904. The cover 904 with the new filter element 906 is then operably mounted in the housing 902, and the filter arrangement 900 is again ready for operation.

1-41. (canceled)

42. A filter element comprising:
(a) a first media construction with first filter media having a tubular shape defining an open filter interior; the first media construction being configured for radial fluid flow through the first filter media;
(b) a second media construction aligned with the first media construction; the second media construction having second filter media;
(c) an end cap construction between the first media construction and the second media construction;
(i) the end cap construction including an outlet arrangement to convey fluid filtered by the second filter media; and
(d) an inlet fluid-conveying tubular member oriented to convey fluid to be filtered to an inlet end of the second filter media.

43. A filter element according to claim 42 wherein:
(a) the end cap construction is axially between the first media construction and the second media construction.

44. A filter element according claim 42 further comprising:
(a) an outer liner circumscribing and supporting the first filter media.

44. A filter element according to claim 42 wherein:
(a) the first filter media comprises pleated media;
(b) the second filter media is configured for axial flow; and
(c) the alignment of the second media construction with the first media construction is an axial alignment.

46. A filter element according to claim 42 further comprising:
(a) a seal member circumscribing the first and second media constructions.

47. A filter element according to claim 46 wherein:
(a) the seal member is configured for axial compression.

48. A filter element according to claim 46 wherein:
(a) the end cap construction is axially between the first media construction and the second media construction.

49. A filter element according to claim 48 wherein:
(a) the end cap construction includes an outer band holding a pair of seal members.

50. A filter element according to claim 42 further comprising:
(a) a center core construction circumscribed by the second filter media; the center core construction including the inlet fluid-conveying tubular member.

51. A filter element according to claim 50 wherein:
(a) the end cap construction is axially between the first media construction and the second media construction;
(i) the end cap construction defining at least one hole accommodating the inlet fluid-conveying tubular member of the center core construction; and
(ii) the outlet arrangement of the end cap construction including at least one outlet hole to convey fluid filtered by the second media construction.

52. A filter element according to claim 51 wherein:
(a) the center core construction includes a bolt-receiving tubular member.

53. A filter element according to claim 52 wherein:
(a) the at least one outlet hole in the end cap construction is defined by a tube projecting from a planar surface; the tube holding and being circumscribed by a seal member.

54. A filter element according to claim 52 wherein:
(a) the center core construction includes a projecting neck with an opening in communication with: (i) the inlet fluid-conveying tubular member; and (ii) the bolt-receiving tubular member;
(i) the neck holding and being circumscribed by first and second seal members;
(ii) the neck being received within the end cap construction hole; the first seal member of the neck forming a seal with the end cap construction at a periphery of the end cap construction hole;
(iii) the second seal member of the neck forming a seal with a filter housing, when the filter element is operably installed within the filter housing.

55. A filter element according to claim 54 wherein:
(a) the center core construction further includes a plug member projecting from an axial portion of the projecting neck; the plug member being circumscribed by a seal member.

56. A filter element according to claim 51 further including:
(a) a lower endcap secured to the first media construction at an end opposite of the end cap construction and including a primary plug member projecting axially therefrom.

57. A filter element according to claim 42 wherein:
(a) the first media construction and the second media construction are each non-round in cross-section.

58. A filter element according to claim 42 wherein:
(a) the first media construction and the second media construction are each obround in cross-section.

59. A filter arrangement comprising:
(a) a filter element including:
(i) a first media construction with first filter media having a tubular shape defining an open filter interior; the first media construction being configured for radial fluid flow through the first filter media;
(ii) a second media construction aligned with the first media construction; the second media construction having second filter media;
(iii) an end cap construction between the first media construction and the second media construction;
(A) the end cap construction including an outlet arrangement to convey fluid filtered by the second filter media;
(b) an inlet fluid-conveying tubular member oriented to convey fluid to be filtered to an inlet end of the second filter media;
(c) a housing defining an interior; the filter element being removably positioned within the housing interior; and
(d) a cover removably positioned on the housing to provide selective access to the filter element.

60. A filter arrangement according to claim 59 wherein:
(a) the housing defines a primary inlet arrangement, a primary outlet arrangement, a secondary inlet arrangement, and a secondary outlet arrangement;
(i) the primary inlet arrangement being in fluid flow communication with an upstream side of the first filter media;
(ii) the primary outlet arrangement being in fluid flow communication with a downstream side of the first filter media;
(iii) the secondary inlet arrangement being in fluid flow communication with an upstream side of the second filter media; and
(iv) the secondary outlet arrangement being in fluid flow communication with a downstream side of the second filter media.

61. A filter arrangement according to claim 60 wherein:
(a) the housing further defines a drain arrangement in liquid communication with the upstream side of the first filter media.

62. A filter arrangement according to claim 59 wherein:
(a) the cover includes a bolt extending in an interior of the cover; the bolt being received by a receiver defined by the housing.

63. A filter arrangement according to claim 62 wherein:
(a) the bolt has a bolt head accessible from an exterior of the cover; and
(b) the bolt extends through the second media construction to the receiver in the housing.

64. A filter arrangement according to claim 59 wherein:
(a) the filter element includes a center core construction circumscribed by the second filter media; the center core construction including the inlet fluid-conveying tubular member in fluid communication with the secondary inlet arrangement;
(b) the first filter media comprises pleated media;
(c) the second filter media is configured for axial flow; and
(d) the alignment of the second media construction with the first media construction is an axial alignment.

65. A filter arrangement according to claim 64 wherein:
(a) the end cap construction is axially between the first media construction and the second media construction;
(i) the end cap construction defining at least one hole accommodating the inlet fluid-conveying tubular member of the center core construction; and
(ii) the outlet arrangement of the end cap construction including at least one outlet hole to convey fluid filtered by the second media construction.

66. A filter arrangement according to claim 65 wherein:
(a) the center core construction includes a bolt-receiving tubular member;
(b) the cover includes a bolt extending in an interior of the cover; the bolt extending through the bolt-receiving tubular member and being received by a receiver defined by the housing.

67. A filter arrangement according to claim 66 wherein:
(a) the center core construction includes a projecting neck with an opening in communication with: (i) the inlet fluid-conveying tubular member; and (ii) the bolt-receiving tubular member;
(i) the neck holding and being circumscribed by first and second seal members;
(ii) the neck being received within the end cap construction hole; the first seal member of the neck forming a seal with the end cap construction at a periphery of the end cap construction hole; and
(iii) the second seal member of the neck forming a seal with the secondary inlet arrangement of the housing.

68. A filter arrangement according to claim 67 wherein:
(a) the center core construction further includes a plug member axially extending from the neck; the plug member including a seal member; and
(b) the housing defines a secondary drain member port; the seal member of the plug member forming a releasable seal with the secondary drain member port.

69. A filter arrangement according to claim 59 wherein:
(a) the filter element further includes a seal member arrangement circumscribing the first and second media constructions.

70. A filter arrangement according to claim 69 wherein:
(a) the seal member arrangement includes a pair of seal members; the seal members being positioned to form axial seals with the housing and cover by compression of the seal members between the housing and the cover.

71. A filter arrangement according to claim 70 wherein:
(a) the cover includes a bolt extending in an interior of the cover; the bolt being received by a receiver defined by the housing;
(b) the bolt has a head extending from an exterior of the cover;
(c) the bolt extends through the second media construction to the receiver in the housing; and
(d) the bolt head is rotatable to turn the bolt and tighten the cover against the housing with the seal member trapped between the cover and housing.

72. A filter arrangement according to claim 59 further comprising:
(a) a fuel pump in the housing; the first filter media circumscribing the fuel pump.

73. A filtration system comprising:
(a) a fuel tank;
(b) a fuel injection system;
(c) a fuel pump arrangement; and
(d) a filter arrangement including:
(i) a filter element comprising a first media construction with first filter media having a tubular shape defining an open filter interior; the first media construction being configured for radial fluid flow through the first filter media; a second media construction aligned with the first media construction; the second media construction having second filter media; an end cap construction between the first media construction and the second media construction; the end cap construction including an outlet arrangement to convey fluid filtered by the second filter media; an inlet fluid-conveying tubular member oriented to convey fluid to be filtered to an inlet end of the second filter media;
(ii) a housing defining an interior; the filter element being removably positioned within the housing interior;
(iii) a cover removably positioned on the housing to provide selective access to the filter element; and
(A) at least a portion of the fuel pump arrangement being in the housing; the first filter media circumscribing the fuel pump arrangement.

74. A system according to claim 73 wherein:
(a) the primary inlet arrangement being in fluid flow communication between the fuel tank and an upstream side of the first filter media;
(b) the primary outlet arrangement being in fluid flow communication between a downstream side of the first filter media and the fuel pump arrangement;
(c) the secondary inlet arrangement being in fluid flow communication between the fuel pump arrangement and an upstream side of the second filter media; and
(d) the secondary outlet arrangement being in fluid flow communication between a downstream side of the second filter media and the fuel injection system.

75. A method of servicing a filter arrangement; the method comprising:
(a) removing a cover from a housing; and
(b) removing a filter element from the housing; the filter element including:
(i) a first media construction with first filter media having a tubular shape defining an open filter interior; the first media construction being configured for radial fluid flow through the first filter media;
(ii) a second media construction aligned with the first media construction; the second media construction having second filter media;
(iii) an end cap construction between the first media construction and the second media construction;
(A) the end cap construction including an outlet arrangement to convey fluid filtered by the second filter media; and
(B) an inlet fluid-conveying tubular member oriented to convey fluid to be filtered to an inlet end of the second filter media.

76. A method according to claim 75 wherein:
(a) the step of removing a cover includes rotating a bolt extending through the second media construction and into a receiver on the housing to release a fastener between the cover and the housing.

77. A method according to claim 75 wherein:
(a) the step of removing a cover includes releasing an axial seal between the cover and the housing.

78. A method according to claim 75 wherein:
(a) the step of removing the filter element from the housing includes removing the first media construction around a pump and around an inlet tube and outlet tube.

79. A method according to claim 75 wherein:
(a) the step of removing a cover and the step of removing a filter element is conducted simultaneously.

80. A method according to claim 79 further including:
(a) disconnecting a latch arrangement between the filter element and the cover.

81. A method according to claim 75 wherein:
(a) the step of removing a cover is done from above the housing.

82. A method according to claim 75 wherein:
(a) the step of removing a cover is done from under the housing.
